(19) United States
(12) Patent Application Publication
(10) Pub. No.: US 2026/0260426 A1
(43) Pub. Date: Sep. 3, 2026

(54) DRAWING ONTO A SURFACE OF A THREE-DIMENSIONAL MESH

(71) Applicant: Microsoft Technology Licensing, LLC, Redmond, WA (US)

(72) Inventors: Miguel Angel Susffalich DIAZ, Kirkland, WA (US); Christopher Douglas EDMONDS, Carnation, WA (US); Yanwei WANG, Bellevue, WA (US)

(73) Assignee: Microsoft Technology Licensing, LLC, Redmond, WA (US)

(21) Appl. No.: 19/068,576

(22) Filed: Mar. 3, 2025

(51) Int. Cl. G06T 17/20; G02B 27/01; G06T 19/20

(52) U.S. Cl. CPC G06T 17/205; G02B 27/0172; G06T 19/20; G06T 2200/24; G06T 2219/2021

(57) ABSTRACT

A parallel processing drawing method operable on a computing device, such as a mixed- or virtual-reality head-mounted display (HMD) device, is utilized to provide a drawing tool that enables a user to virtually draw a line on a mesh of primitive geometric objects (e.g., triangles) that model three-dimensional (3D) surfaces of virtual or real-world objects. A device user provides inputs to a user interface on the computing device to virtually draw a line that the drawing tool then renders on a display system. The parallel processing drawing method simultaneously computes each of the individual line segments to conform the virtually drawn line to the mesh. The method is computationally efficient compared to conventional ray tracing which facilitates applications such as quick marking and drawing on meshes including complex meshes representing terrain and irregularly shaped objects.

### BACKGROUND

Mixed-reality computing devices, such as head-mounted display (HMD) and handheld mobile devices (e.g., smart phones, tablet computers, etc.), may be configured to display virtual objects using virtual images and/or real objects in a field of view (FOV) of an HMD device user and/or a field of view of a camera of the device. For example, an HMD device may be configured to display, using a see-through display system, virtual environments with real-world objects mixed in, or real-world environments with virtual objects mixed in.

### SUMMARY

A computing device is configured to provide a drawing tool to a device user for virtually drawing lines onto a mesh of primitive geometric elements used for a three-dimensional model of surfaces of one or more objects in a scene that is rendered on a display system. A method utilized to conform the user's virtually drawn line to mesh surfaces with high accuracy is optimized for parallel processing so that individual segments used for rendering the line on the display system are computed simultaneously. This parallel processing drawing method supports a drawing tool that is responsive to user inputs with minimal latency while using computing resources efficiently which is advantageous in resource-limited computing environments such as those implemented in HMD devices.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### DESCRIPTION OF THE DRAWINGS

FIG. 1 shows an illustrative mixed-reality head-mounted display (HMD) device;

FIG. 2 shows illustrative computing components used in an HMD device;

FIG. 3 shows an illustrative example of a processing unit used in an HMD device;

FIG. 4 shows an illustrative graphics rendering pipeline implemented in a computing system of an HMD device;

FIG. 5 shows illustrative components of a display system and a user interface of an HMD device;

FIG. 6 illustratively shows virtual images that are overlayed onto real-world images within a field of view (FOV) of a mixed-reality HMD device;

FIGS. 7-9 show an HMD device user in a physical environment interacting with illustrative virtual objects;

FIGS. 10-13 show illustrative hand motions and gestures from the perspective of the HMD device user in the FOV of an HMD device;

FIG. 14 shows an HMD device user employing hand motions to virtually draw a line for rendering on a virtual object;

FIG. 15 shows a line rendered on a virtual object by a drawing tool from a first viewpoint of an HMD device user;

FIG. 16 shows a line rendered on a virtual object by a drawing tool from a second viewpoint of an HMD device user;

FIGS. 17A and 17B show an HMD device user employing hand motions to virtually draw a line for rendering on a real-world object;

FIG. 18 shows a drawing path from a viewpoint of an HMD device user;

FIG. 19 shows a virtual line rendered by a drawing tool and conformed to a real-world object from a viewpoint of an HMD device user;

FIG. 20 is an illustrative flowchart for a parallel processing drawing method in accordance with the present principles;

FIGS. 21-24 and 26-29A-29B show illustrative steps in a parallel processing drawing method as applied to portions of a mesh for a three-dimensional (3D) model of an object;

FIG. 25 is an illustrative flowchart for a process for selecting triangle intersection segments for rendering;

FIG. 30 shows an illustrative rendering line segment generated from a triangle intersection segment;

FIG. 31 shows an illustrative complex mesh that models a section of terrain;

FIG. 32 shows illustrative rendering of MGRS (military grid reference system) lines on terrain using conventional ray tracing;

FIG. 33 shows illustrative rendering of MGRS lines on terrain using a parallel processing drawing method in accordance with the present principles;

FIG. 34 shows illustrative rendering of lines drawn by a user over a large scale area using a parallel processing drawing;

FIG. 35 shows illustrative extensions to a parallel processing drawing method providing additional capabilities;

FIG. 36 is an illustrative flowchart of a method for synthesizing lines for rendering in instances where a mesh has overlapping portions;

FIG. 37 is an illustrative flowchart of a method for optimizing groups of user-drawn lines and/or curves;

FIG. 38 is an illustrative flowchart of a method to extend a parallel processing line drawing method to virtual painting on a 3D mesh;

FIGS. 39-41A and 41B are flowcharts of illustrative methods arranged in accordance with the present principles;

FIG. 42 is a pictorial view of an illustrative example of a mixed-reality HMD device that may be arranged in accordance with the present principles;

FIG. 43 shows a block diagram of an illustrative example of a mixed-reality HMD device arranged in accordance with the present principles; and

FIG. 44 shows a block diagram of an illustrative electronic device that supports a parallel processing drawing tool arranged in accordance with the present principles.

Like reference numerals indicate like elements in the drawings. Elements are not drawn to scale.

### DETAILED DESCRIPTION

Disclosed are a method, computer-readable storage device, and head-mounted-display (HMD) device pertaining to a parallel processing drawing method utilized by a drawing tool that is exposed to a computing device user for virtually drawing lines in a mixed- or virtual-reality environment. The user-drawn lines are rendered on a display system to closely conform to surfaces of an object, which may be a virtual-world or real-world object, that is modeled in three dimensions (3D) using a mesh of primitive geometric objects such as triangles.

In response to user inputs to a user interface provided on a computing device representing a virtually-drawn line, the parallel processing drawing method simultaneously computes individual line segments for the line to conform to the object's surfaces. In an illustrative example in which triangles are used in the mesh, the method includes projecting the user-drawn line onto the mesh where the projected line has a range defined by a starting and ending point. Triangles that intersect with a plane containing the user-drawn line are identified. Points intersecting with the plane along edges of each intersecting triangle are found and connected to form candidates for triangle intersection segments that are used for rendering the conformed line.

Candidates for the triangle intersection segments are excluded from rendering when both of their intersecting points are outside the range defined by the starting and ending points of the projected line. Candidates are included for rendering when both of their intersection points are inside the range. A candidate that has one or the other of its intersecting points outside the range is modified so that the outside point is replaced by the nearer of either the starting point or ending point of the projected line.

Each of the triangle intersection segments is used to create a respective rendering line segment. Each rendering line segment comprises primitive geometric objects, for example a pair of triangles arranged as a rectangle, to provide the conformed line with attributes during rendering such as width, color, texture, and the like. The rendering line segments are aggregated and rendered on the display system as the conformed line on the object's surfaces.

The parallel processing drawing method is extensible in some embodiments to provide additional features and optimization. An illustrative extension includes painting user-selected portions of an object. The user virtually draws a line or groups of lines to define a perimeter of a closed shape conformed to the surfaces of an object that is filled with a color, texture, shading, or the like.

An illustrative extension includes line culling to remove line segments that are not visible to the user. Culling can reduce computation load on the computing device and improve efficiency of the rendering of the conformed line.

Synthesizing line segments is another illustrative extension for rendering in situations where the projection of the drawn line results in multiple opened or closed lines. This situation may occur, for example, when there are multiple overlapping meshes and/or a complex mesh has overlapping portions.

Another illustrative extension of the parallel processing drawing method includes optimizations for simultaneously rendering multiple user-drawn lines onto multiple meshes. Each conformed line has its own associated bounding information which is utilized to determine whether a given line is included or excluded from computations for a given mesh.

In some HMD device embodiments, a user interface utilizes one or more of a body tracking system and an eye tracking system. Body and eye tracking systems enable the user to employ, for example, their eyes, head, hands, fingers, etc. to control the drawing tool using gaze direction, body motions, gestures, and the like. Such human-machine interfaces can be utilized to replace or supplement other types of user interfaces to the drawing tool and HMD device such as physical interfaces (e.g., handheld controllers, mice, styluses, pens, buttons, actuators, touchscreens, and the like) and microphone/audio interfaces for voice-based control.

Some HMD device embodiments are arranged to include depth sensing capabilities for capturing detailed spatial information about real-world objects in the environment surrounding the HMD device. Using one or more of a variety of sensor types, the HMD device measures distances to generate 3D representations which can be processed into meshes to model the objects. Such HMD device-generated meshes may be utilized to supplement or replace meshes that are generated or provided from sources that are external to the HMD device. For example, meshes that model virtual-world and real-world objects may be obtained using a standalone device such as a handheld 3D scanner. Alternatively, an HMD device can be connected via a communications network to a local computing device or data source and/or to a remote or cloud-based service that provides suitable meshes to which the parallel processing drawing method is applied.

The parallel processing drawing method is designed to make efficient use of computing resources by performing the computations for creating triangle intersection segments as a workload having concurrently executable tasks. For example, in some embodiments, a graphics processing unit (GPU) in the computing device includes a compute shader that executes separately and independently from a graphics rendering pipeline on the GPU that handles general rendering tasks. Computation tasks associated with triangle intersection segments are thus performable in the compute shader in parallel to the creation and rendering of the rendering line segments in the graphics rendering pipeline to display the conformed line on the HMD device's display system.

The parallel processing drawing method is designed to represent the conformed lines and meshes using data elements that are well-suited for concurrent processing by the compute shader. By computing the triangle intersection segments simultaneously in a single pass in the compute shader, GPU resources are efficiently utilized. In resource-constrained environments, which commonly occur in many HMD device platforms, efficient processing by the drawing tool can improve the quality of user experience through increased responsiveness of the tool with reduced latency, while reducing consumption of limited resources including, for example, computation cycles, memory, and power.

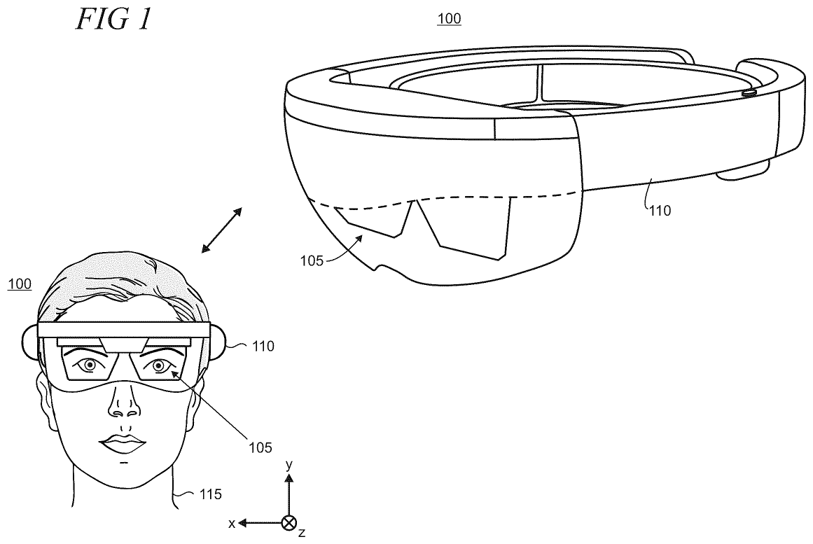

Turning now to the drawings, FIG. 1 shows a pictorial partially cutaway view of an illustrative mixed-reality HMD device 100. In this example, the HMD device includes a display system 105 and a frame 110 that wraps around the head of a user 115 to position the display system near the user's eyes to provide a mixed-reality experience to the user. Alternative virtual-reality HMD devices may utilize a similar form factor to that of HMD device 100 but utilize different display systems, as discussed further below.

For a mixed-reality experience, the display system 105 is typically see-through so that the user 115 can view physical, real-world objects in the surrounding physical environment over which pixels for virtual objects are overlayed. For example, the display system may include one or more partially transparent waveguides used in conjunction with a virtual image-producing imaging system or display engine. Alternatively, an external forward-facing camera is usable to capture video images of the surrounding physical environment, and those captured images are rendered on the display system 105 in a pass-through configuration along with computer-generated virtual images that augment the captured images of the physical environment. To provide virtual-reality experiences, a display system in a virtual-reality HMD device is typically opaque to external light (i.e., not see-through) and images of the surrounding physical environment are generally not displayed.

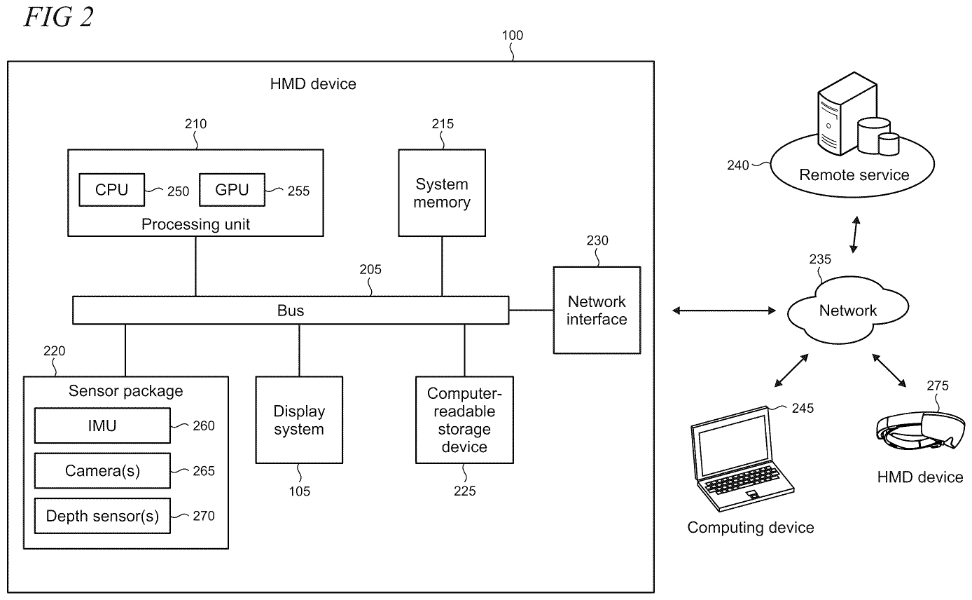

FIG. 2 shows illustrative computing components that are typically used in the HMD device 100. The components share a common communication bus 205 that operatively and functionally couples the components. The computing components include, for example, the display system 105, a processing unit 210, a system memory 215, a sensor package 220, a computer-readable storage device 225 or other computable-readable media, and a network interface 230. The network interface facilitates communications over a network 235 with other devices, resources, and services, for example a remote (e.g., cloud-based) service 240, a computing device 245 such as a personal computer (PC), smartphone, peripheral device, 3D scanning device, and the like, and/or other HMD devices 275.

In some HMD device implementations, the HMD device 100 shares resource utilization with the computing device 245, for example using a tethered arrangement. In other implementations, remote cloud-computing resources are accessed over the network to supplement or substitute for functionalities that are provided locally at the HMD device such as computing, graphics processing, data storage, and the like.

The processing unit 210 includes, in this illustrative example, a central processing unit (CPU) 250 and a graphics processing unit (GPU) 255. Note that the CPU and GPU are shown in FIG. 2 as discrete components for illustrative purposes. However, in some embodiments, one or more aspects of the described CPU and GPU may be integrated into a single device or processing unit. In some HMD device embodiments, a dedicated artificial intelligence (AI) chip or processor (not shown) may be included in the processing unit.

The system memory 215 typically includes RAM (random access memory) and ROM (read only memory) that are used by the processing unit 210 for various tasks and computations. The computer-readable storage device 225 typically is used for storing software code or other computer-executed instructions that are utilized, for example, to implement applications, a file system, and an operating system for the HMD device 100.

The sensor package 220 is typically configured to include a variety of sensors that operate alone or in combinations, via sensor fusion, to collect information and data used by the HMD device 100 to provide an immersive and interactive experience. Such sensors can include, for example, an inertia measurement unit (IMU) 260, cameras 265, and depth sensors 270. Other sensors (not shown) may also be utilized as needed for a particular HMD device implementation such as ambient light and color sensors, sound sensing devices (e.g., microphones), health-monitoring sensors, and other sensors.

The IMU typically combines an accelerometer, gyroscope, and/or magnetometer. By integrating data from these sensors, the IMU can accurately track head position and orientation and movements within the 3D space of the physical environment surrounding the HMD device 100.

The cameras 265 may include, for example, infrared (IR) cameras and visible light cameras. Outward-facing cameras are utilized for user position tracking and/or body tracking, and inward-facing cameras for eye tracking and/or facial gesture tracking.

The depth sensors 270 may include, for example, one or more of time-of-flight (ToF) sensors, stereo-vision sensors, structured light sensors, or LIDAR (light detection and ranging) to capture detailed spatial information and data about the physical environment surrounding the HMD device 100. Such sensors utilize various underlying technologies to measure distances and generate 3D representations which can be processed into 3D models, for example, by the processing unit 210 in the HMD device, a remote service, an external computing device, or by using a combination of devices and services.

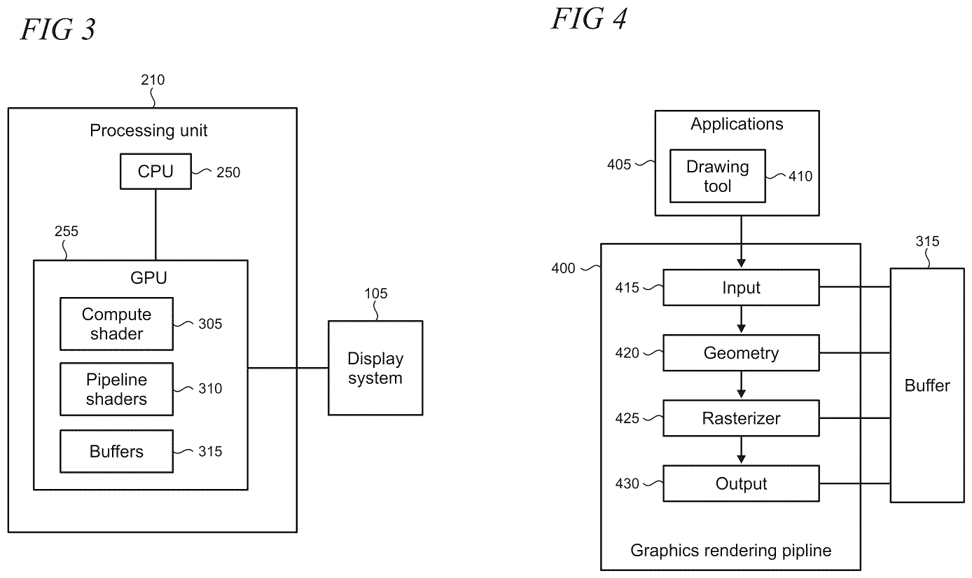

FIG. 3 shows an illustrative example of the processing unit 210 that provides data used for visual display of virtual content using the display system 105 by processing computer-executable instructions in the CPU 250 and GPU 255. The instructions executed in the GPU implement a compute shader 305 and various other pipeline shaders 310. The GPU further supports memory buffers 315 that may be implemented in either or both hardware and software.

The compute shader 305 is a programmable shader stage running on the GPU 255 separately and independently from the normal graphics rendering pipeline 400 shown in FIG. 4. Compute shaders provide high-speed general-purpose computing and leverage the large number of parallel processors on the GPU for a variety of different tasks including both graphics and non-graphics tasks. Workloads that are well-suited for the compute shader 305 execute with increased speed and utilize resources with increased efficiency compared with conventional processes such as ray tracing that run on a graphics rendering pipeline. The use of compute shaders further enables some tasks to be offloaded from the CPU 250 to the GPU 255.

The present parallel processing drawing method is specifically designed to generate workloads that are mapped to the compute shader running on the GPU 255. Computations for drawing on meshes, particularly including complex and/or large meshes, are performed concurrently by the compute shader. As discussed in more detail below, the compute shader handles computations for the vector-handling parts of the present drawing method. Other shaders 310 executing on the GPU 255 may be used alone or in conjunction with hardware processors, to compose and render the pixels for raster images for the conformed line on the display system 105.

The graphics rendering pipeline 400 shown in FIG. 4 is available to various applications 405 that execute to support various features and user experiences on the HMD device 100. The graphics rendering pipeline is an illustrative non-limiting example and suitable variations to its architecture and operation may be utilized to meet the needs of a particular HMD device and/or drawing tool implementation.

The applications 405, in this illustrative example, include a drawing tool 410 that incorporates the present principles. The user 115 can employ the drawing tool application to virtually draw lines on modeled virtual objects displayed by the HMD device. In addition, in some implementations as discussed further below, the drawing tool is configured for the user to virtually draw lines on modeled real-world objects.

The graphics rendering pipeline 400 includes an input stage 415, a geometry stage 420, a rasterizer stage 425, and an output stage 430. Each stage may utilize the buffers 315 provided in the GPU 255 as needed. The input stage reads primitive data (e.g., points, lines, triangles, or other geometric elements) from the buffers 315 and assembles the data into primitives used by the other pipeline stages.

The geometry stage includes shaders 310 which typically include vertex shaders that transform individual vertices from 3D model and world spaces to the 2D screen space. In some implementations, tessellation shaders and geometry shaders are utilized for respectively providing fine-grained control over surface details and processing vertices and creating new vertices.

The rasterization stage converts vector information (composed of shapes or primitives) into a raster image (composed of pixels) for the display system 105. In some implementations, additional post-rasterization stages and/or shaders are utilized, such as pixel shaders, prior to the output stage 430 which outputs the final-rendered pixels using a combination of the pipeline state and the pixel data from the pixel shader.

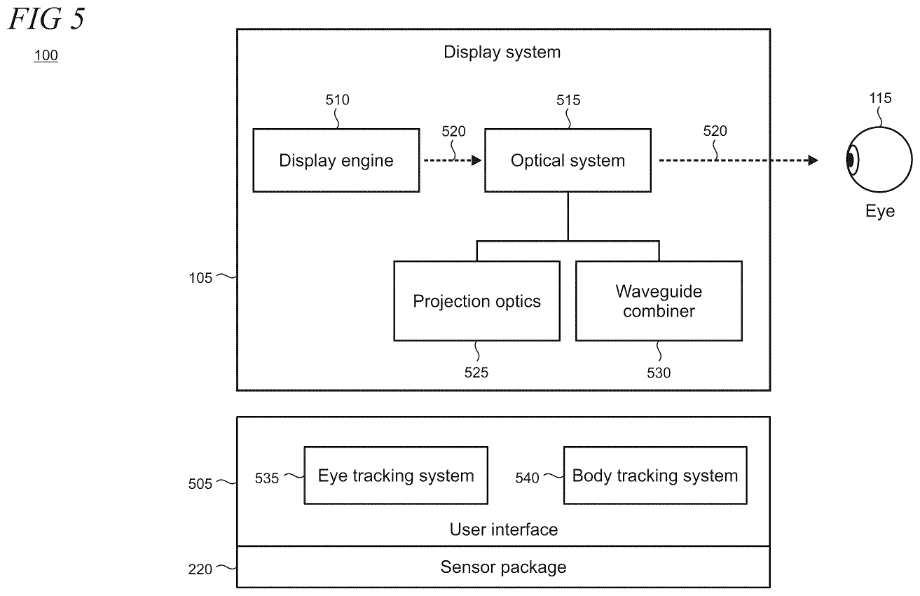

FIG. 5 shows illustrative components of the display system 105 and a user interface 505 of the mixed-reality HMD device 100. The display system includes a display engine 510 and an optical system 515 to provide virtual and real images to the user 115 over a light path 520. The optical system may include projection optics 525 (e.g., magnifying and/or collimating lenses, MEMS devices, or the like), and a waveguide combiner 530.

The display engine 510 may include one or more sources of virtual images (e.g., images representing objects from a virtual world) that interoperate with the waveguide combiner 530 to deliver virtual images to a user's eye 115. The waveguide combiner is a see-through element so that the virtual images are displayed in conjunction with the user's view of the real-world surroundings.

Any suitable technology and configuration may be used to display virtual images using the display system 105. For example, the display engine 510 may include a light-emitting diode (LED) display, a liquid crystal display (LCD), a liquid crystal on silicon (LCoS) display panel, a micro-electromechanical system (MEMS) scanner display system, or any other suitable type of display device or micro-display that operates in transmission, reflection, or emission.

The sensor package 220 is utilized, typically in part, to implement a user interface 505 for the HMD device 100 that includes an eye tracking system 535 and a body tracking system 540. The user interface is provided to supplement other user interfaces such as voice-based systems, brain-computer interfaces, and systems that wholly or partly utilize or embody physical controls. The user interface may also support conventional tools and peripheral devices for drawing applications in some implementations, such as mice, pointing devices, pens, styluses, etc. The user interface 505 enables the user 115 to interact with the HMD device 100 to engage in a variety of mixed-reality user experiences including virtually drawing on objects using the drawing tool 410.

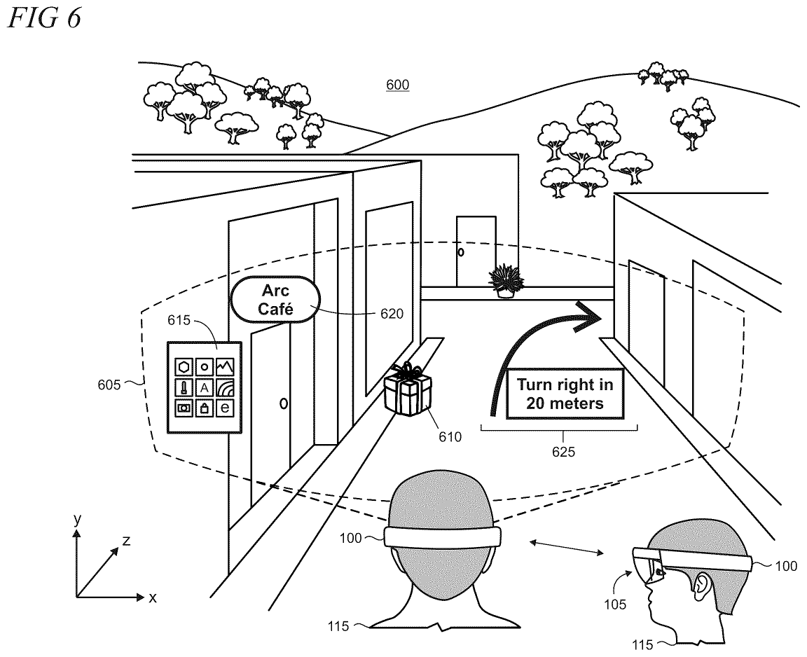

FIG. 6 shows the HMD device 100 worn by a user 115 as configured for mixed-reality experiences. As noted above, the display engine 510 (FIG. 5) generates virtual images that are guided by the waveguide in the display system 105 to the user. Being see-through, the waveguide combiner 530 (FIG. 5) in the display system enables the user to perceive light from the real world. The display system renders images of various virtual objects that are superimposed over the real-world images that are collectively viewed using the see-through waveguide combiner to thereby create a mixed-reality environment 600 within the HMD device's FOV 605. It is noted that the FOV of the real world and the FOV of the images in the virtual world are not necessarily identical, as the virtual FOV provided by the near-eye display system is typically a subset of the real FOV. FOV is typically described as an angular parameter in horizontal, vertical, or diagonal dimensions.

In the illustrative example shown in FIG. 6, the user 115 is physically walking in a real-world urban area that includes city streets with various buildings, stores, etc., with a countryside in the distance. The FOV 605 of the cityscape viewed on HMD device 100 changes as the user moves through the real-world environment and the device can render static and/or dynamic virtual images over the real-world view. In this illustrative example, the virtual images include an object 610, a graphical user interface 615 comprising a variety of user-selectable icons, a tag 620 that identifies a business, and directions 625 to a place of interest in the city. The mixed-reality environment 600 seen visually on the display system 105 is also supplemented by audio and/or tactile/haptic sensations (e.g., vibrations, force feedback, etc.) produced by the HMD device and/or peripheral devices such as controllers and haptic gloves in some implementations.

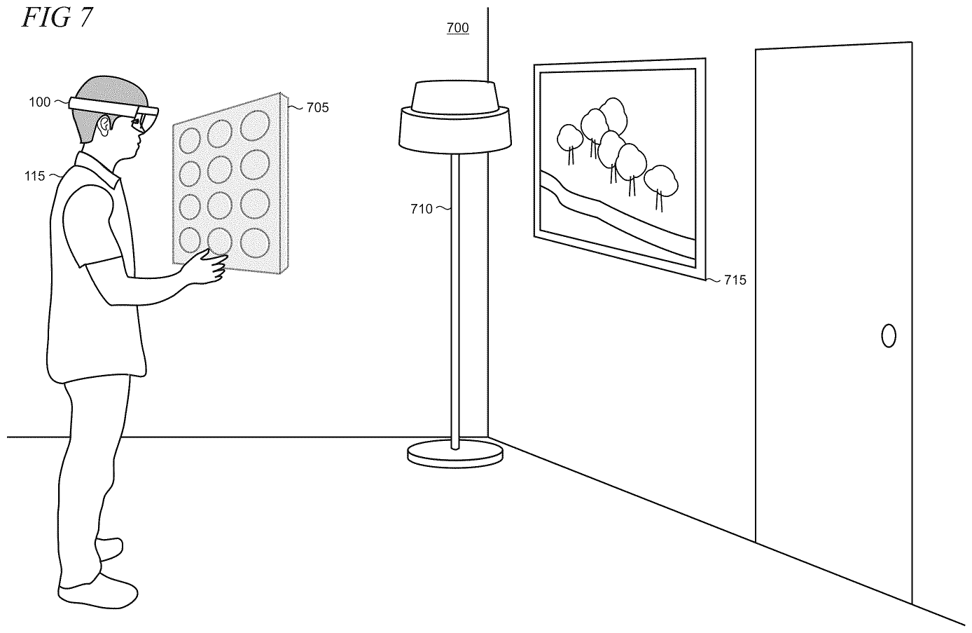

FIG. 7 shows an illustrative physical environment 700 in which the user 115 interacts with a virtual object 705 that is viewable by the user through the display system 105 on the HMD device 100. The object is a vertically oriented panel that includes a number of user-actuatable buttons. It is noted that the depiction in the drawing is made from the point of view of an observer as if the virtual object were real. It may be appreciated that the virtual object 705 can only be viewed using a suitable device and is not, for example, projected into free space to allow viewing by the naked eye of an observer. The physical environment 700 includes real-world objects such as a lighting fixture 710, and wall art 715. Although not labeled with reference numerals, the floors, walls, and door are also part of the physical environment.

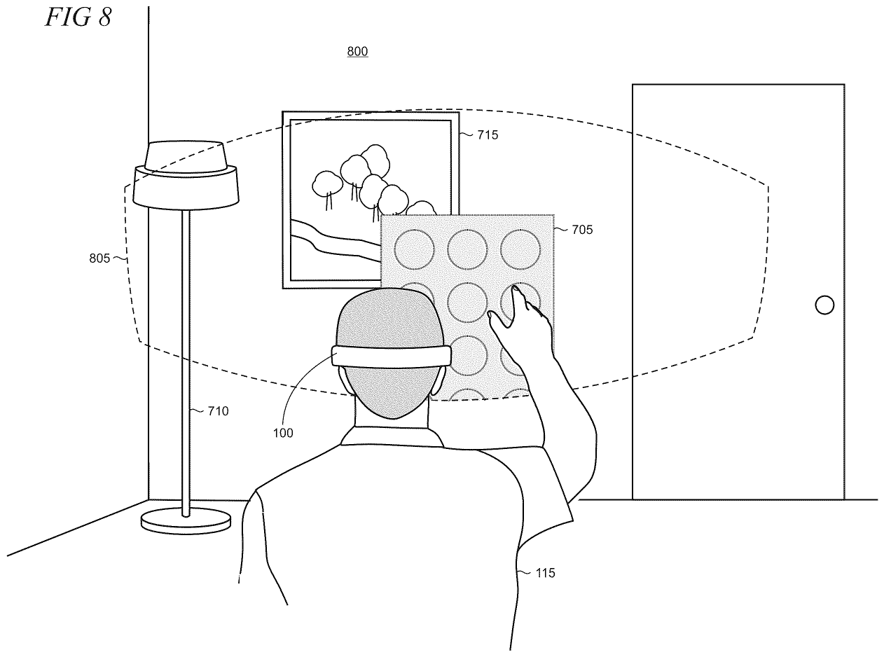

FIG. 8 shows an FOV 805 of an illustrative mixed-reality scene 800 as viewed using the waveguide combiner 530 in the display system 105 from the perspective of the user 115. The user can see portions of the physical environment 700 and the virtual object 705 rendered by HMD device 100. Applications can generally place virtual objects anywhere in the physical environment as needed for a given mixed-reality experience. However, applications often locate virtual objects between one-half to five meters from the user to minimize user discomfort from, for example, vergence-accommodation conflict. The user can thus interact with virtual objects that are close by or at a distance.

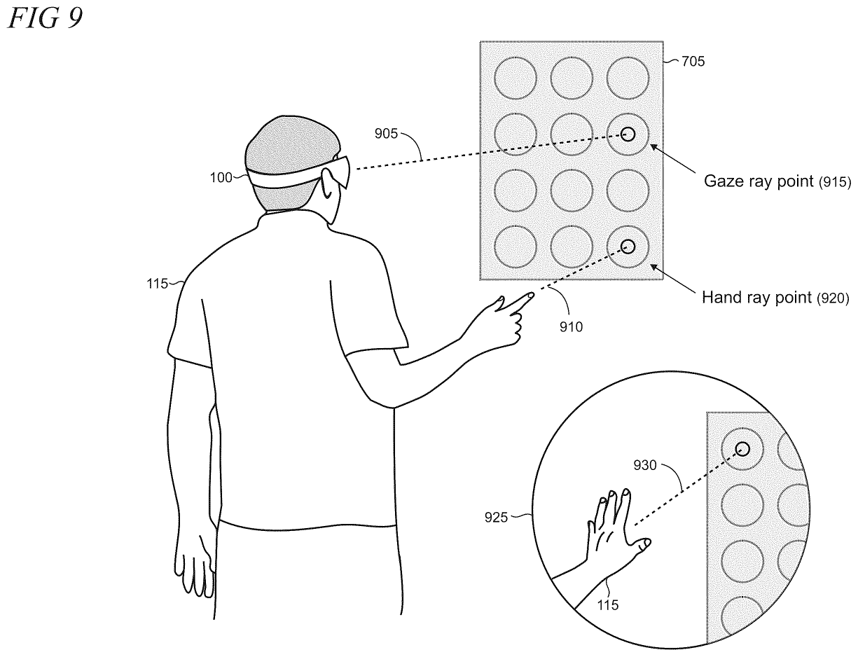

The eye tracking system 535 and body tracking system 540 are usable to implement a ray-casting pointing system in the user interface 505 of the HMD device. FIG. 9 shows the user 115 interacting with the virtual object 705 at a distance using their eyes for pointing a gaze ray 905 along a vector direction within a scene. A hand ray 910 may also be provided where the user's finger is utilized as a pointing device. The rays intersect with the object at respective gaze ray and hand ray points 915 and 920.

The gaze ray 905 is typically projected from a point of origin between the eyes of the user 115. Thus, the gaze ray 905 corresponds with the HMD device user's line of sight and, as such, the gaze ray's viewpoint is aligned with the user's visual focus within a given scene rendered within the FOV of the HMD device 100. By comparison, the point of origin of the hand ray 910 is at the user's hand. The viewpoint associated with the hand ray is therefore taken from the user's hand position which can move independently from the user's head.

The independence between viewpoints of the user's eyes and hands can provide increased flexibility when using the drawing tool 410. For example, using hand rays can provide an extended spatial range of manipulations and interactions with objects. The user 115 can use hand rays to draw on parts of an object outside the user's direct line of sight or where it would be awkward to access from other viewpoints or positions.

The disparity between viewpoints of the user's hand and natural line of sight can feel unintuitive for some users, for example, when the parallax between viewpoints is large when the hand is extended way outside the line of sight. However, such issues can be minimal in typical use scenarios. Use of the drawing tool 410 feels natural and intuitive since many users will tend to look at their hands (i.e., position them along or near their line of sight) when drawing just as they typically do when using traditional real drawing media.

The body tracking system 535 further enables the HMD device 100 to track the user's hands to enable direct interaction with virtual objects. In addition to drawing directly on close-by objects using the drawing tool 410, for example, the user can reach out and touch objects which can trigger various interactions or selections. The user can grasp, rotate, scale, or translate virtual objects in some interactive use cases or change object properties such as color and texture. Various virtual interactive elements can be provided to assist the user in direct interactions, such as menus, buttons, grab points and handles, and other types of manipulation widgets, user interface components, or virtual tools.

When interacting with virtual objects at a distance, the points of intersection between the gaze and/or hand rays and the virtual object may be displayed to the user, for example using a cursor, pointer, or other graphic indicator. The rays themselves are not typically displayed to the user, although they can be shown in some implementations. Audio and/or haptic feedback may also be utilized to indicate points of intersection to the user in some cases. When interacting with virtual objects that are close by, the locations of contact points between the user and the object can be displayed or otherwise provided as feedback to the user to signal contact, or imminent contact in some cases, with the object using suitable visual cues, audio, haptic feedback, etc.

The particular gestures of the user 115 utilized as inputs can vary by implementation. For example, the user may employ a finger of their right hand as a pointer, as shown. The body tracking system 540 tracks its location and orientation in the environment to generate the hand ray 910 and determine the intersecting hand ray point with the virtual object 705. In an alternative arrangement shown in the circle 925, the body tracking system is arranged to project a hand ray 930 from the tracked palm of the user's left hand.

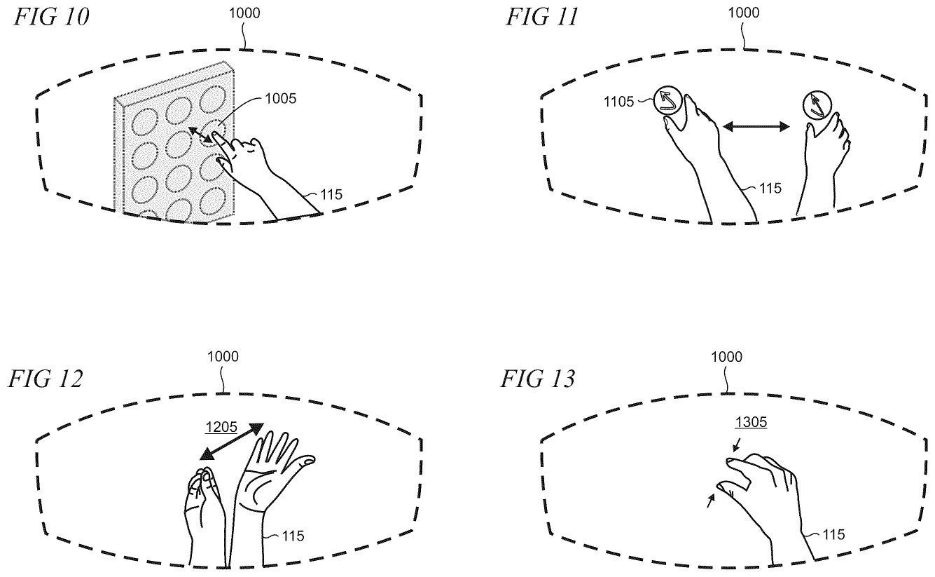

FIGS. 10-13 show illustrative hand motions, poses, and gestures (collectively referred to as “gestures”) from the perspective of the HMD device user 115 in the FOV 1000 of the HMD device 100 when interacting with virtual objects. Such gestures may utilize directional cues including, for example, but not by way of limitation, side-to-side, up and down, back-and-forth, in-and-out, diagonal, and other motions. The gestures may be suitably adapted for particular types, attributes, properties, and behaviors of virtual objects and the distance of the object from the user during interaction (i.e., whether close by or at a distance).

FIG. 10 shows the user 115 using a tapping gesture to operate a virtual button 1005. FIG. 11 shows the user interacting with a close-up virtual object 1105 by selecting (for example by performing a tapping gesture) and then grabbing and moving the virtual object. FIG. 12 shows the user's in and out movements within the mixed-reality space, for example by performing a “bloom” gesture 1205. FIG. 13 shows a pinch gesture 1305 by fingers of the user. Other directional movements not shown in FIGS. 10-13 are also possible while the user operates the HMD device 100, such as circular movements, figurate movements, and various hand gestures which include manipulating the user's fingers, etc.

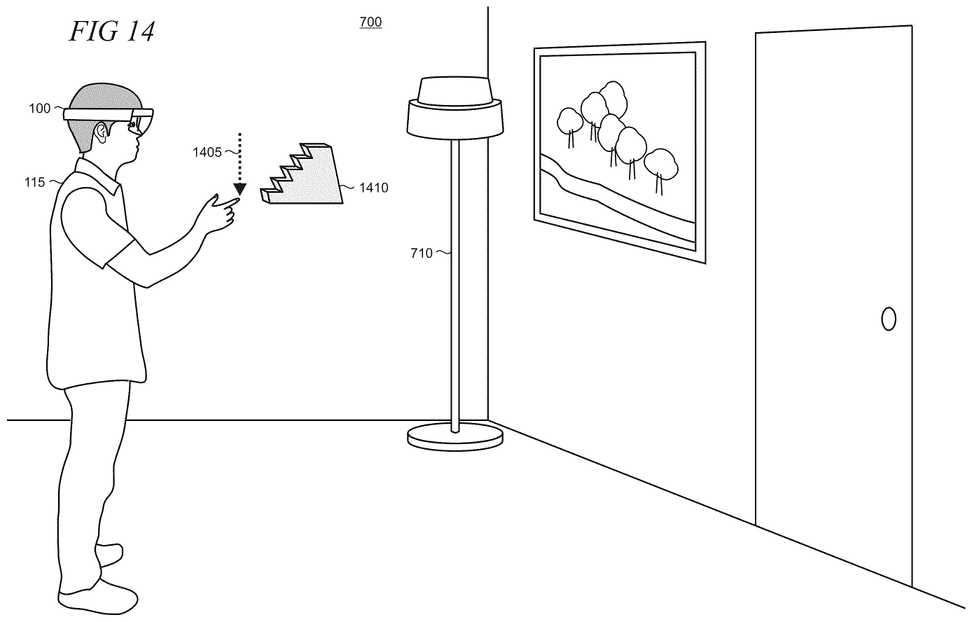

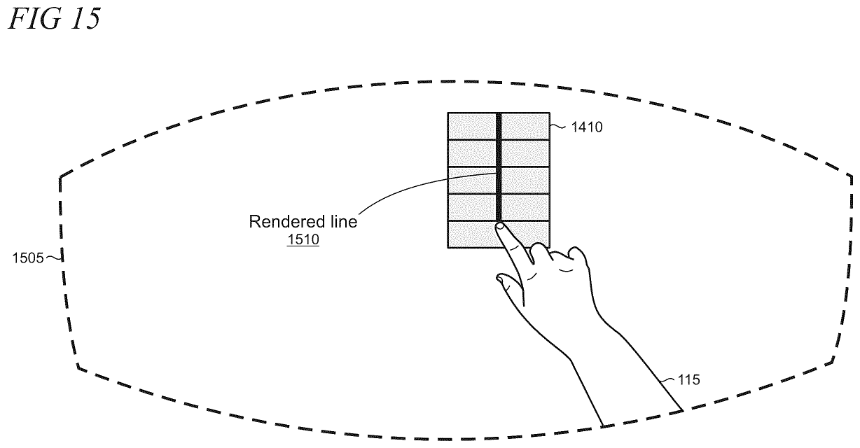

FIGS. 14 and 15 show the user 115 employing a vertical hand motion, indicated by the dashed arrow 1405, to virtually draw a line for rendering on a virtual object 1410 using the drawing tool 410. The user can indicate the start and end points for the line using a variety of inputs to the drawing tool, for example, tapping motions to initiate and end the drawing, voice commands, or other gestures or input to the user interface.

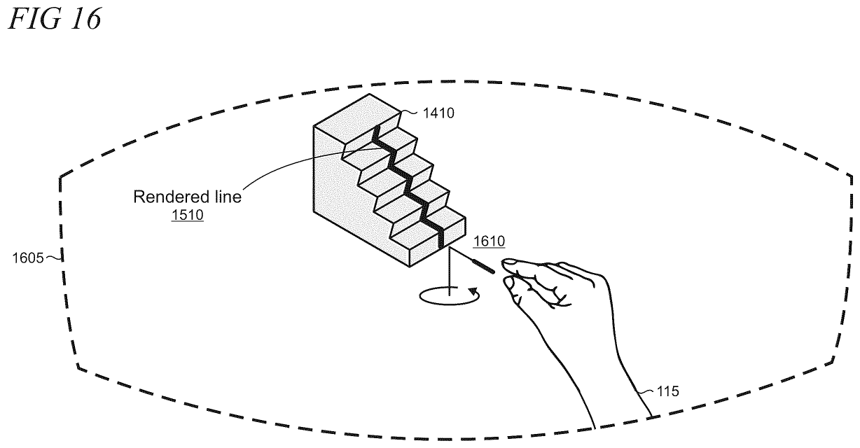

From the viewpoint of the user 115 in the FOV 1505 of the HMD device shown in FIG. 15, both the vertical hand motion and the rendered virtual line 1510 appear straight. As shown in the FOV 1605 in FIG. 16, if the user rotates the virtual object 1410 using, for example, a virtual handle 1610, then the user's view of the object is changed. The changed view shows that the drawing tool 410 renders the virtual line to conform with the surfaces of the virtual object.

In the discussion of the present principles that follows, illustrative examples are provided in which a single line is drawn by the user over a drawing path having straight paths between two points in space—a starting and an ending point. The single user-drawn object is referred to as a “line” which is rendered and displayed by the HMD device display system. The drawing tool may use multiple segments, as appropriate, to conform the rendered line to an object on which the line is drawn. Thus, the drawing path of the line in space and the line rendered by the display system to conform to the object's surfaces can appear different depending on viewpoint.

The single straight-line examples are used for clarity in exposition of the present principles. However, the drawing tool 410 can handle the virtual drawing of complex line shapes that are typically defined by multiple points or vertices including bends and curves and multiple sections. A line drawn by the user with a complex shape is referred to herein as a “curve.” The drawing tool 410 approximates curves with complex shapes as a collection of multiple straight-line primitives termed “line segments.” The approximation simplifies computation complexity and takes advantage of the drawing tool's parallel processing for simultaneous calculation of all lines drawn by a user in a given context whether comprising a single line or multiple segments in a curve.

In some implementations, the drawing tool 410 renders the virtual line on the display system 105 in real time to match the user's drawing inputs. Such real-time feedback supports interactivity between the user and the drawing tool to make the drawing experience immediate and intuitive. Real-time rendering can also facilitate collaborative efforts with other HMD device users through shared visualizations and communication enabled by the drawing tool.

The drawing tool 410 provides a fast and efficient way for the user to directly draw lines on 3D model surfaces with high precision. For example, in response to quick and simple movements of the user's hands and/or eyes, the drawing tool creates virtual lines that conform tightly to the surfaces of the mesh for the object. Thus, the user can exercise fine-grained control over the drawn lines with the speed and simplicity of freehand sketching.

In some implementations, the drawing tool 410 displays the drawing path made by the user 115. For example, the drawing path for a virtual line is rendered on the display system 105 of the HMD device 100 (FIG. 1) in real time with the tracked motion of the user's hand. In some cases, showing the drawing path provides more intuitive feedback to the user as compared with showing the line conformed to an object by the drawing tool. Some meshes of virtual or real objects, for example, are complex and/or have irregular surfaces. Depending on the user's viewpoint with respect to the object, showing the drawing path can be helpful to the user to obtain the desired line when rendered on the object.

When configured to display the drawing path to the user 115, the drawing tool 410 can render the drawing path in the “air” surrounding the user's fingertip, for example. A variety of user experiences can be supported such as saving drawing paths and selectively applying the drawings paths to see the path rendered as a conformed line on the object. Such drawing path visualization features can help the user, for example, with large drawing projects by reapplying drawing paths to different parts of the object. Drawing path visualization may also enable the user to experiment with different paths to determine how a particular path will be conformed to the object by the drawing tool.

The drawing tool 410 may be further configured to enable the user 115 to edit and modify a drawing path in some implementations. In addition, the drawing path tool may be further configured to simultaneously display the drawing path and the line as conformed to the object. The drawing path and conformed line can be sequentially displayed in some cases. The drawing path and conformed line can also be selectively displayed responsive to user input. The drawing path and conformed line can be rendered using different attributes such as color, line width, texture, shading and other lighting effects, and the like to help differentiate the lines to the user.

As noted above, the drawing tool 410 is configurable to enable the HMD device user 115 to draw virtual lines directly on virtual objects that are close by or at a distance from the user. In both cases, the user 115 can use mid-air drawing strokes that the drawing tool projects onto the intended surfaces of the object. In addition to handling virtual objects, the drawing tool is configurable, in some implementations, to enable the user to draw virtual lines on real-world objects that are modeled using 3D meshes of primitive geometric objects such as triangles. An illustrative use case for the real-world object drawing feature is, for example, an HMD device user working in an architectural firm marking real objects in a room to highlight points of interest to be viewed by colleagues who are also outfitted with suitable mixed-reality HMD devices.

As discussed above, the HMD device 100 (FIG. 1) is configured in some cases with depth sensors that operate to capture detailed spatial information about real-world objects in the use environment surrounding the device. The depth sensors measure distances which can be used to generate 3D representations of the object which can be internally processed by the HMD device and/or processed by external computing devices or services into meshes. Alternatively, suitable pre-existing 3D models of real-world objects in the use environment can be accessed and utilized by the drawing tool 410. In some cases, data or partial and/or complete meshes generated by the HMD device can be subjected to post-processing by another computing device and/or service to further develop, refine, or optimize a mesh. In other cases, depth data can be captured by the HMD device as a point cloud and then subjected to subsequent processing by another computing device and/or service to generate an appropriate mesh.

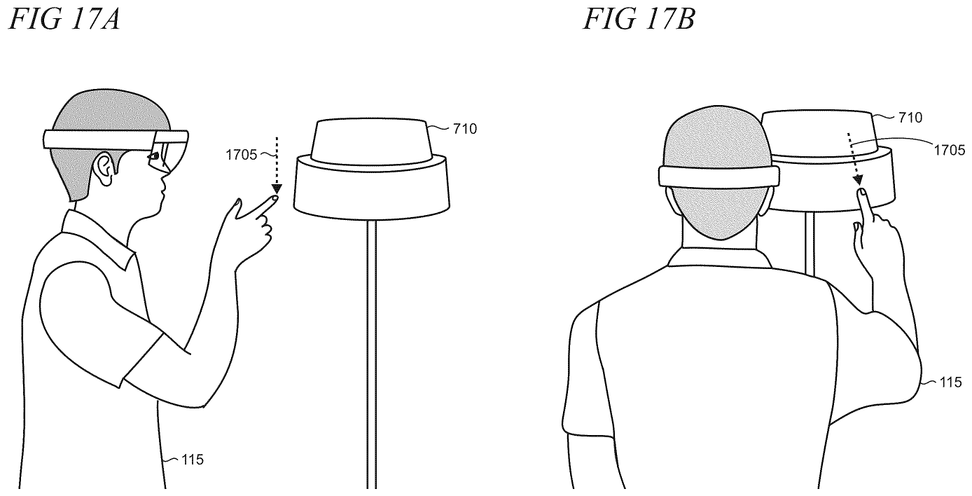

FIGS. 17A and 17B show the HMD device user 115 employing a vertical hand motion, indicated by the dashed line 1705, to virtually draw a line that appears to be conformed to surfaces of a real-world object when rendered. In this illustrative example the real-world object is a light fixture 710. While FIG. 17A shows the user being relatively close to the object, the drawing tool 410 does not require that the user physically touch the object to draw on it. In addition, the drawing tool is effective in scenarios in which the user is at a distance from the objects being drawn upon. For example, as discussed below, landscape architects may use the drawing tool to quickly and accurately overlay virtual markings on areas of real terrain to visualize and mark potential changes to landscape projects.

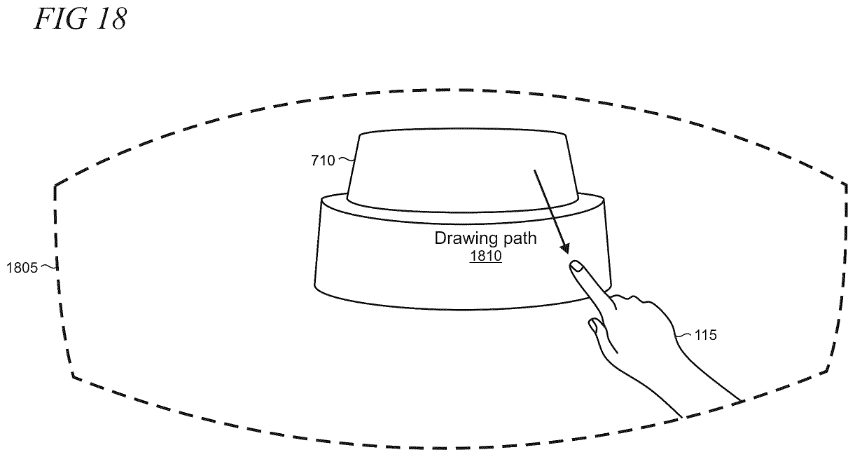

FIG. 18 shows the viewpoint of the user 115 in the FOV 1805. Line 1810 is the straight drawing path made by the motion of the user's tracked finger. The user starts the line, moves their finger down, and ends the line. As noted above, the drawing path from the tracking can be visibly displayed on the display system 105 as feedback to the user in some implementations.

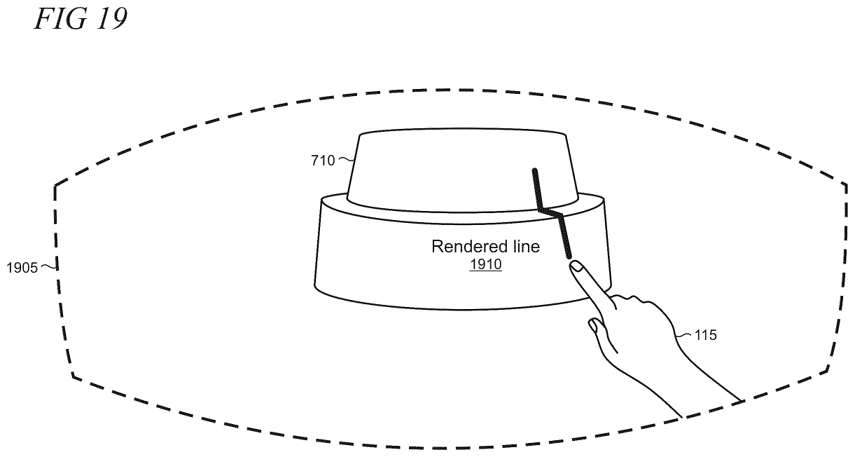

FIG. 19 shows a virtual line 1910 as rendered by the drawing tool 410 and conformed to the real-world light fixture 710 from a viewpoint of the eyes of the HMD device user 115 in the FOV 1905. The line is conformed to the surfaces of the light fixture and displayed in real time as the user moves their hand along the corresponding drawing path. Since the HMD device user's viewpoint at the position of their eyes differs from the viewpoint at the position of their hand, the projected line does not appear straight when conformed to the surfaces of the light fixture.

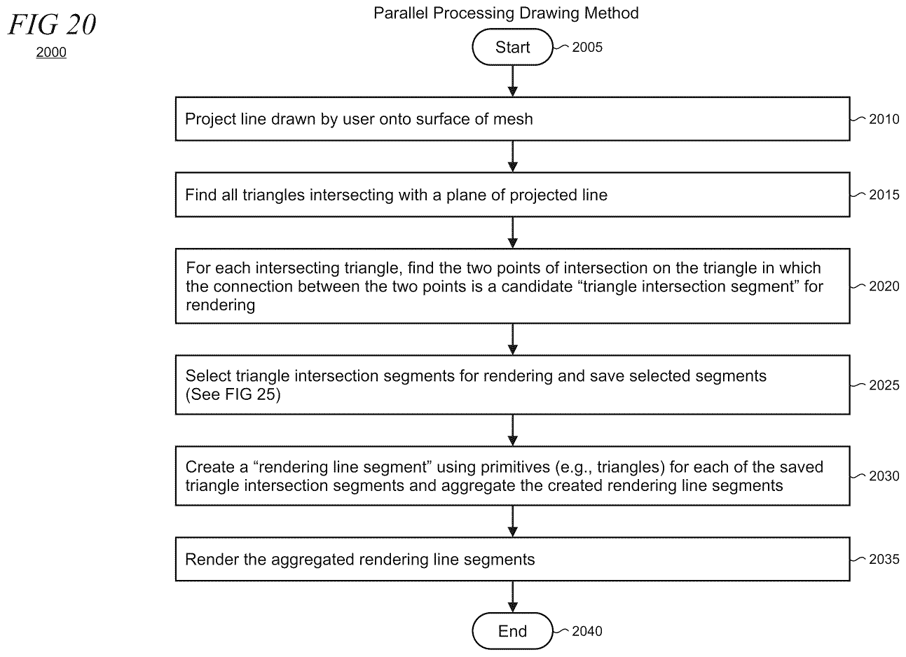

FIG. 20 is an illustrative flowchart 2000 for a parallel processing drawing method utilized by the drawing tool 410 in accordance with the present principles. Unless specifically stated, the methods or steps shown in the flowchart and described in the accompanying text are not constrained to a particular order or sequence. In addition, some of the methods or steps thereof can occur or be performed concurrently and not all the methods or steps have to be performed in a given implementation depending on the requirements of such implementation and some methods or steps are optionally utilized.

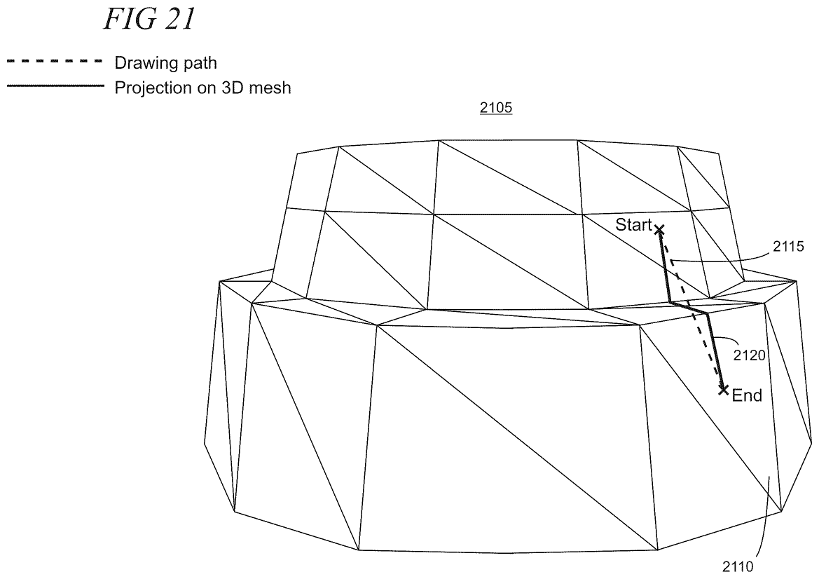

The parallel processing drawing method is generally applicable to a mesh representing a 3D model of an object of interest having surfaces on which the user 115 draws. In an illustrative example, the mesh represents a 3D model of a real-world object with reference to FIGS. 21-24 and 26-29A-29B which depict the real-world light fixture example discussed above. However, as discussed above, the drawing tool is configurable to enable drawing on meshes for either or both virtual and real-world objects.

The method starts at block 2005 responsive to the user 115 using the drawing tool to generate a drawing path. The drawing path represents a straight line defined by a starting point and an ending point in this example. The drawing tool 410 determines the drawing path using tracked gaze or body motions or through some other input by the user to the user interface of the HMD device 100.

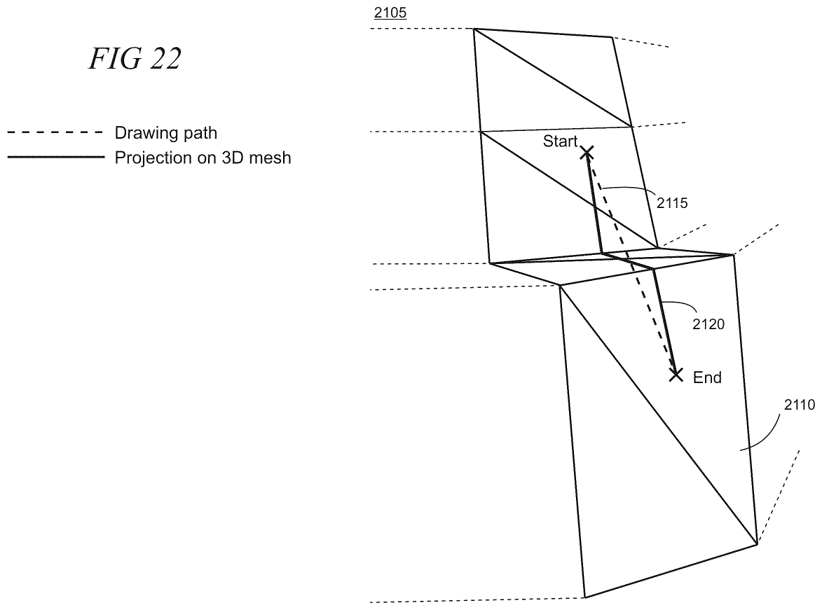

Block 2010 includes projecting a line corresponding to the tracked drawing path onto a mesh 2105, as shown in FIG. 21. FIG. 22 shows an enlarged view of the relevant portion of the mesh. FIGS. 21 and 22 show the mesh from the viewpoint of the user 115. The mesh represents a mathematical 3D model of the light fixture. The mesh is not shown to the user in typical use cases but can be displayed and/or edited or otherwise manipulated by the user with the drawing tool 410 in some implementations.

The mesh 2105 comprises primitive geometric polygons in the form of triangles, as representatively indicated with reference numeral 2110. Other types of polygons may also be utilized for meshes for some implementations of the drawing tool 410. However, triangles are generally well suited for the meshes because they can accurately approximate surfaces of objects of any shape. Triangles have a property of planarity (i.e., triangles cannot be non-planar) which can make computations faster and more efficient. The mesh is constructed using an arbitrary number of triangles in this illustrative example to facilitate discussion of the present principles.

It may be appreciated that increasing the number of triangles in a given mesh enhances accuracy of its associated 3D model by providing a more precise approximation of the modeled object's shape, particularly for objects having curved and/or complex surfaces. Using more triangles can further enable the capture of finer details of the surface of the 3D model. Handling higher triangle counts requires more processing power and memory, so resource consumption is typically balanced against rendering speed and display quality, particularly with HMD devices which tend to be resource-limited. Advantageously, the parallel processing enabled by the design of the drawing tool 410 can provide for fast rendering of lines that are conformed against surfaces of even large-scale complex meshes such as those modeling large areas of terrain, as discussed further below.

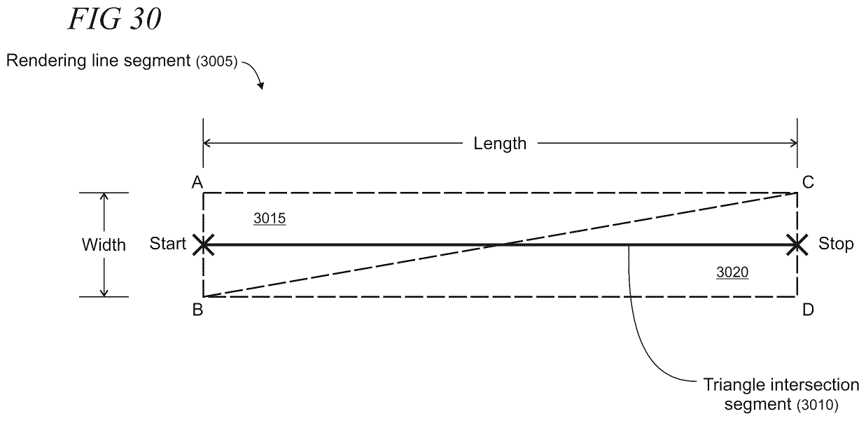

The drawing path is indicated by a dashed line 2115 and its projection is indicated by a thick line 2120 in FIGS. 21 and 22. The drawing path and projection represent mathematical vectors having dimensions of length and direction that are used for computation by the drawing tool 410 but the vectors do not have a width dimension. In this illustrative example, the vector lines are represented in FIG. 22 for purposes of explanation of the present principles. To be displayable to the user 115 on the display system 105 in the HMD device 100 (FIG. 1), the vectors are used to create associated rendering line segments to provide the width dimension. Rendering line segments are built from geometric primitives (e.g., triangles), as discussed further below in the text accompanying FIG. 30.

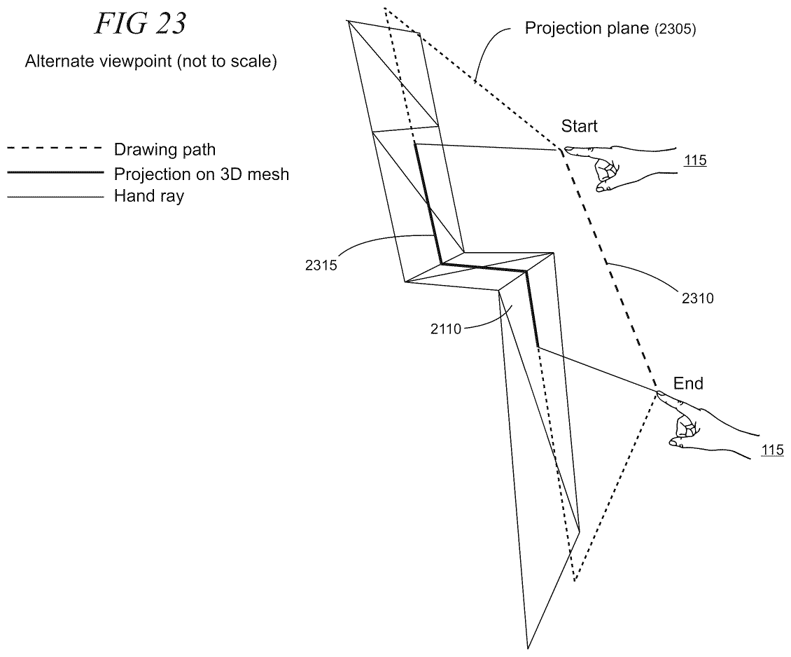

Block 2015 in the flowchart in FIG. 20 includes finding triangles in the mesh that intersect with a plane of the projected line. The projection plane is indicated by reference numeral 2305 in FIG. 23. It is noted that FIG. 23 shows an alternate viewpoint of the mesh that is different from the user's viewpoint shown in FIGS. 21 and 22 to facilitate depiction of the 3D projection plane using a 2D drawing. The projection plane 2305 is defined by the starting and ending points of the projected line and a hand ray origin point (e.g., at a fingertip or palm). Accordingly, the drawing path 2310 and projected line 2315 are both contained in the projection plane 2305, as shown.

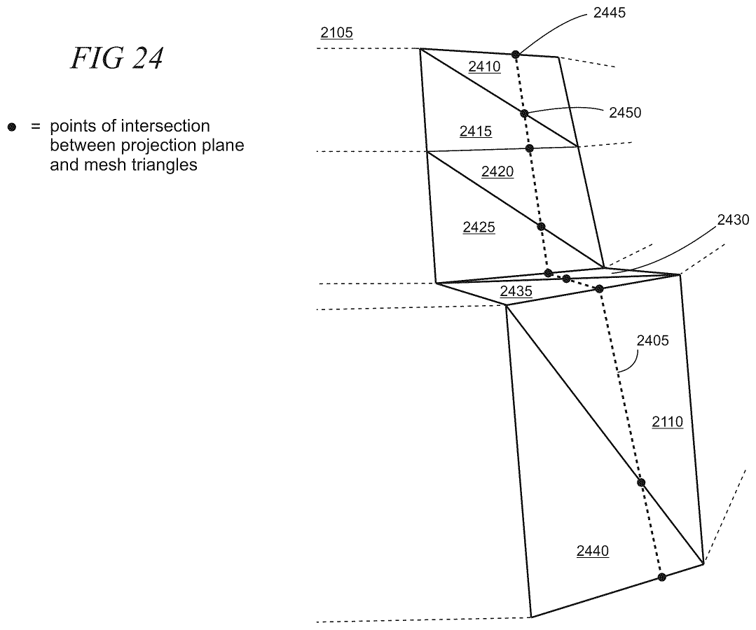

The dashed line 2405 in FIG. 24 indicates the intersection of triangles in the mesh 2105 and the projection plane 2305. As shown, triangles 2410, 2415, 2420, 2425, 2430, 2435, 2110, and 2440 intersect with the projection plane.

Block 2020 in the flowchart 2000 in FIG. 20 includes, for each intersecting triangle with the projection plane 2305, finding the two points on the triangle that intersect with the projection plane. The points of intersection are indicated by the black circles in FIG. 24. Reference numeral 2445 indicates a representative intersection point. It may be appreciated that the points can overlap for adjacent triangles in the mesh, as representatively indicated by reference numeral 2450 for triangles 2410 and 2415.

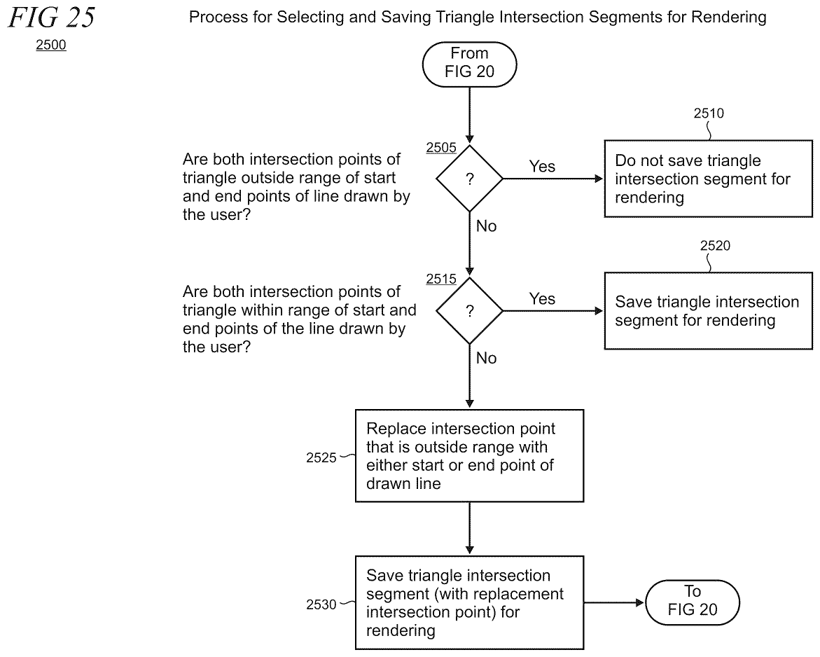

Lines connecting the points of intersection for each of the intersecting triangles form candidates for what are termed “triangle intersection segments.” Block 2025 in the flowchart in FIG. 20 includes selecting and saving suitable candidates for a subsequently-implemented rendering process. In typical cases, multiple triangle intersection segments are computed simultaneously for a given user-drawn line. The selection and saving process is shown in the flowchart 2500 in FIG. 25 which is applied to each of the candidate triangle intersection segments before returning to the flowchart 2000 in FIG. 20.

At decision block 2505 in the flowchart 2500 in FIG. 25, if both of the intersection points of a triangle are outside a range defined by the starting and ending points of the projection of the line drawn by the user, then at block 2510, the candidate triangle intersection segment is not saved for rendering and is discarded. That is, no line is rendered for that discarded candidate. At decision block 2515, if both of the intersection points of a triangle are inside the range defined by the starting and ending points, then at block 2520, the candidate is a triangle intersection segment that is saved for rendering.

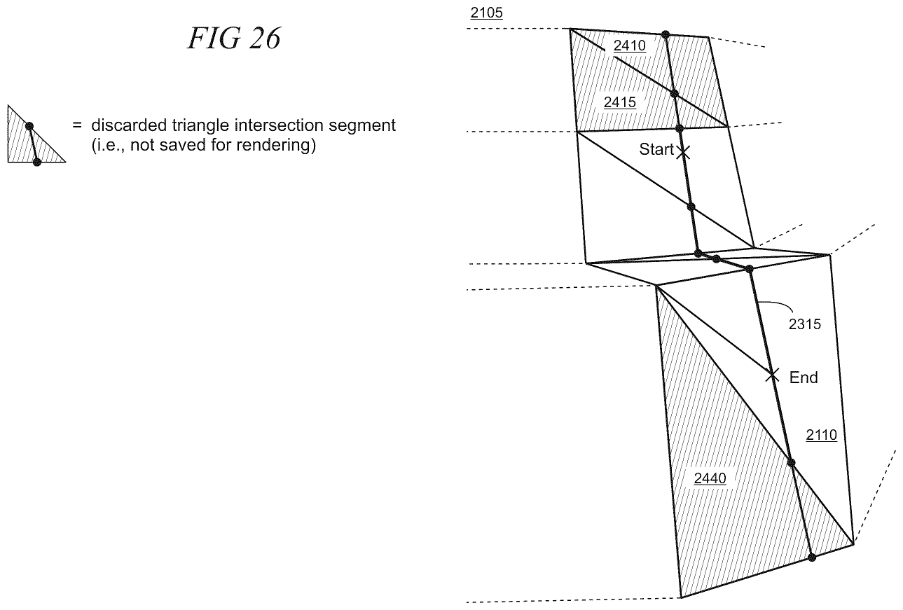

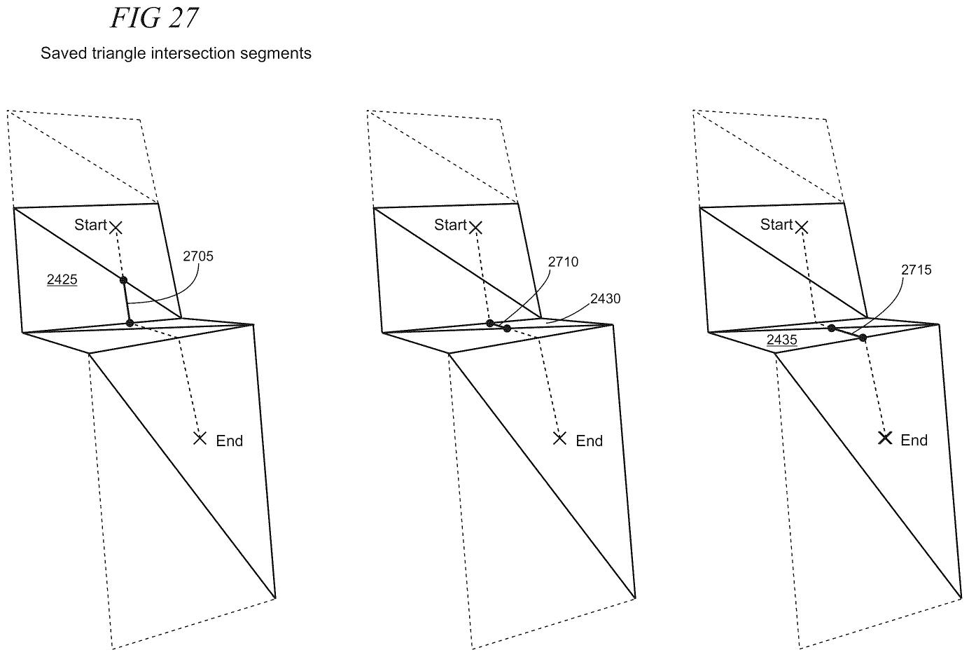

FIG. 26 shows application of process blocks 2505 and 2510 to triangles in the light fixture example. Candidate triangle intersection segments for triangles 2410, 2415, and 2440 are not saved and are discarded. Triangle intersection segments 2705, 2710, and 2715 in respective triangles 2425, 2430, and 2435 are saved for subsequent rendering, as shown in FIG. 27.

At block 2525 in the flowchart 2500 in FIG. 25, candidates having one of the two intersection points that are outside the range of the projection of the user-drawn line are modified to replace the outside point with a nearer of the starting or ending point. The candidate triangle intersection segment, as modified with the replacement point, is a triangle intersection segment that is saved for rendering, at block 2530. Control is then passed back to the flowchart 2000 in FIG. 20.

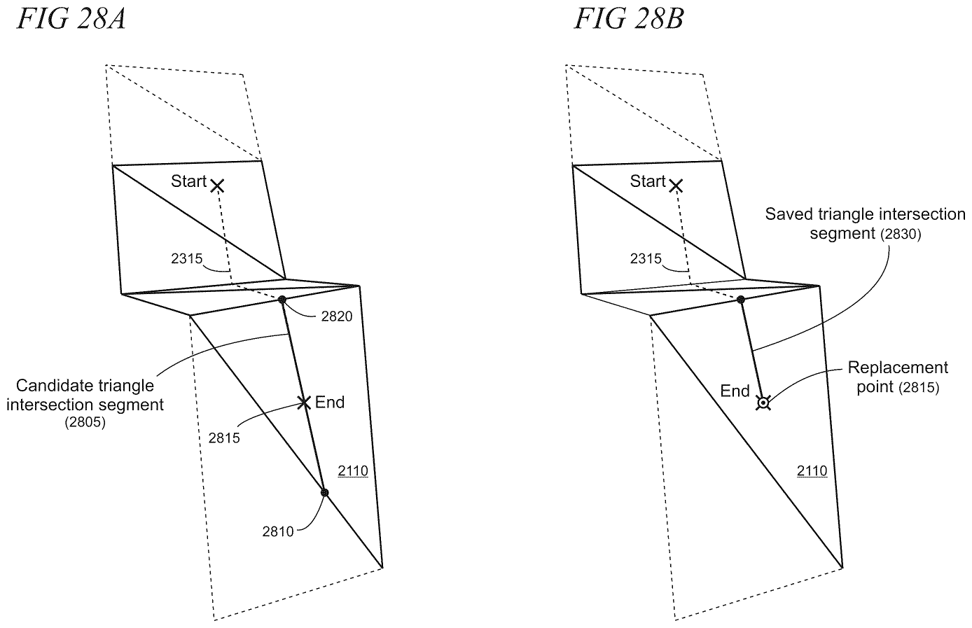

FIGS. 28A and 28B show the application of process blocks 2525 and 2530 from the flowchart 2500 in FIG. 25 to a candidate triangle intersection segment 2805 in triangle 2110. As shown in FIG. 28A, the candidate triangle intersection segment 2805 has an intersection point 2810 that is beyond the ending point 2815 of the projected line 2315. The other intersection point 2820 is within the range of the projected line. As shown in FIG. 28B, the outside point 2810 is replaced by the replacement point 2815 at the ending point location of the projected line. The resulting triangle intersection segment 2830 is saved for rendering.

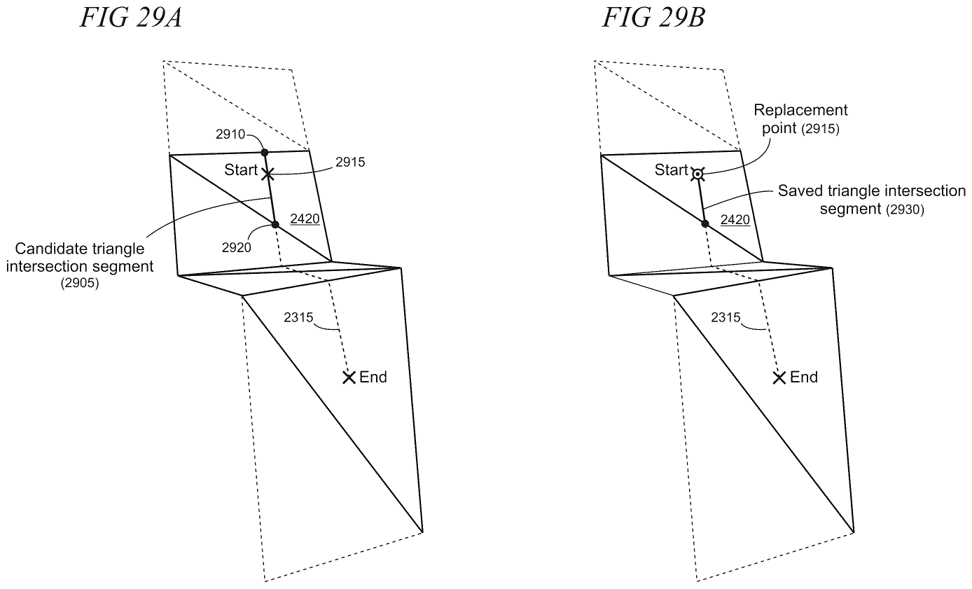

FIGS. 29A and 29B show the application of process blocks 2525 and 2530 from the flowchart 2500 in FIG. 25 to a candidate triangle intersection segment 2905 in triangle 2420. As shown in FIG. 29A, the candidate triangle intersection segment 2905 has an intersection point 2910 that is beyond the starting point 2915 of the projected line 2315. The other intersection point 2920 is within the range of the projected line. As shown in FIG. 29B, the outside point 2910 is replaced by the replacement point 2915 at the starting point location of the projected line. The resulting triangle intersection segment 2930 is saved for rendering.

Returning to the flowchart 2000 in FIG. 20, the parallel processing drawing method continues at block 2030. The triangle intersection segments saved in the preceding step of the process are used to create what are termed “rendering line segments” which are aggregated. The aggregated rendering line segments are rendered by the display system 105 of the HMD device 100 (FIG. 1) on the mesh, at block 2035, so that the user-drawn virtual line is conformed to the surfaces of the modeled object. The parallel processing drawing method ends at block 2040.

FIG. 30 shows an illustrative rendering line segment 3005 that is created from a saved triangle intersection segment 3010 using primitives such as a pair of triangles forming a rectangular shape (as indicated by the dashed line). As shown, a first triangle 3015 has vertices A, B, and C. A second triangle 3020 has vertices C, D, and B. The triangles 3015 and 3020 are right triangles in this illustrative example and geometrically arranged to share a common hypotenuse. The legs of the triangles 3015 and 3020 that are parallel to the triangle intersection segment 3010 are the same length as the segment 3010. The other legs (i.e., that are orthogonal to the triangle intersection segment 3010) represent the width of the rendering line segment.

The triangles forming the rendering line segments provide faces having length and width that may be utilized by the drawing tool 410 for applying attributes such as color, texture, lighting, shading, and the like during rendering. The rendering line segments are typically processed conventionally by suitable stages of the graphics rendering pipeline 400 described above with reference to FIG. 4.

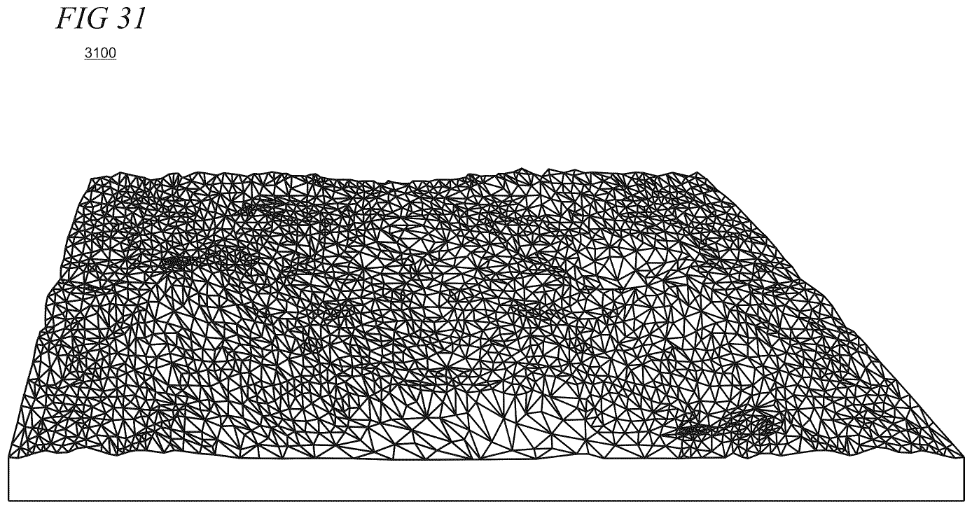

While the previous illustrative examples show the HMD device user 115 drawing on relatively small virtual objects (FIG. 14) and real objects (FIGS. 17A and 17B), the drawing tool 410 supports the drawing of virtual lines in large scale scenes where the meshes and modeled objects can be large and complex. For example, FIG. 31 shows an illustrative mesh 3100 for an area of terrain.

Modeling terrain with meshes can be challenging because the terrain topology can be complex with overlapping contours and features having different elevations. Detailed terrain models generally have high polygon counts and the irregularity of features can add processing complexity because polygon locations are random and unpredictable. Incorporating natural elements such as trees and water and manmade structures such as buildings and roads into an irregular terrain model can result in additional mesh complexity. Trees often have varying and irregular heights and buildings have planar features and edges that represent a sharp contrast to the underlying terrain.

Achieving accurate and precise virtual line drawing over 3D modeled terrain and objects (e.g., manmade structures, natural objects such as trees, etc.) means that points along drawn lines are conformed to the mesh with sufficient frequency to ensure that the lines match up with the varying elevations. Conventional rendering techniques like ray tracing often struggle to accurately depict lines on complex 3D meshes due to their reliance on sampling methods for feature extraction, which can lead to imprecise or incomplete representation of intricate surface details. Increasing sample counts improves accuracy but also raises computational costs which can be problematic when dealing with large and complex meshes. Using ray tracing with resource-constrained computing platforms such as HMD devices can therefore result in drawn lines appearing to float and/or intersect incorrectly with the mesh. Such discrepancies may be particularly observable at locations on the mesh, for example at buildings and trees, that present abrupt changes in elevation.

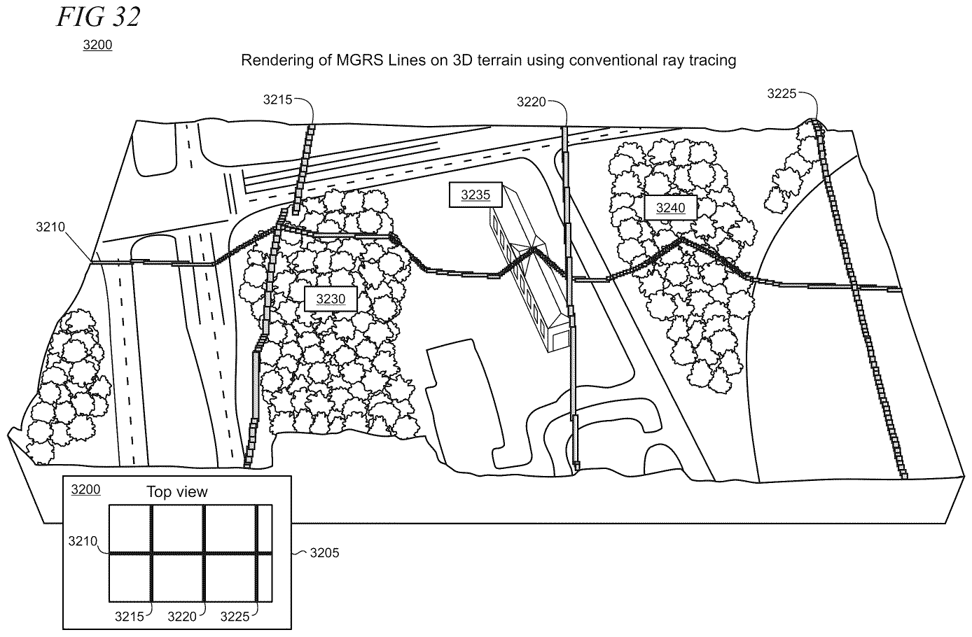

FIG. 32 shows an illustrative example of a section of terrain 3200 that is modeled with a mesh (not shown). Lines drawn on the mesh using a drawing program employing conventional ray tracing are shown in FIG. 32. The lines are aggregated from individual line segments to represent, for example, MGRS (Military Grid Reference System) lines that are part of a 2D grid for uniquely identifying location on Earth. Accordingly, MGRS lines appear straight from a viewpoint of an observer looking at the terrain from above in the direction towards the center of the Earth, as shown in the reduced-size top view indicated by reference numeral 3205. Four MGRS lines are shown, as indicated by reference numerals 3210, 3215, 3220, and 3225. The real-world distance between adjacent MGRS lines (e.g., line 3215 and 3220) is 100 meters in the drawing.

From a viewpoint shown in FIG. 32, it can be observed that the MGRS lines do not conform precisely to the contours of all the features on the terrain. For example, observing the MGRS line 3210 from left to right, the line has a gap to the left of the trees 3230. The MGRS line 3210 has a flat section over the top of trees 3230, which does not accurately conform to the variations in elevation in that area and leaves another gap to the right of the trees 3230. The MGRS line 3210 leaves gaps at both the left and right sides of the building 3235 which represent an abrupt variation in the elevation. The MGRS line 3210 does not accurately conform to the variations in elevation at the trees 3240 at the right side of the drawing.

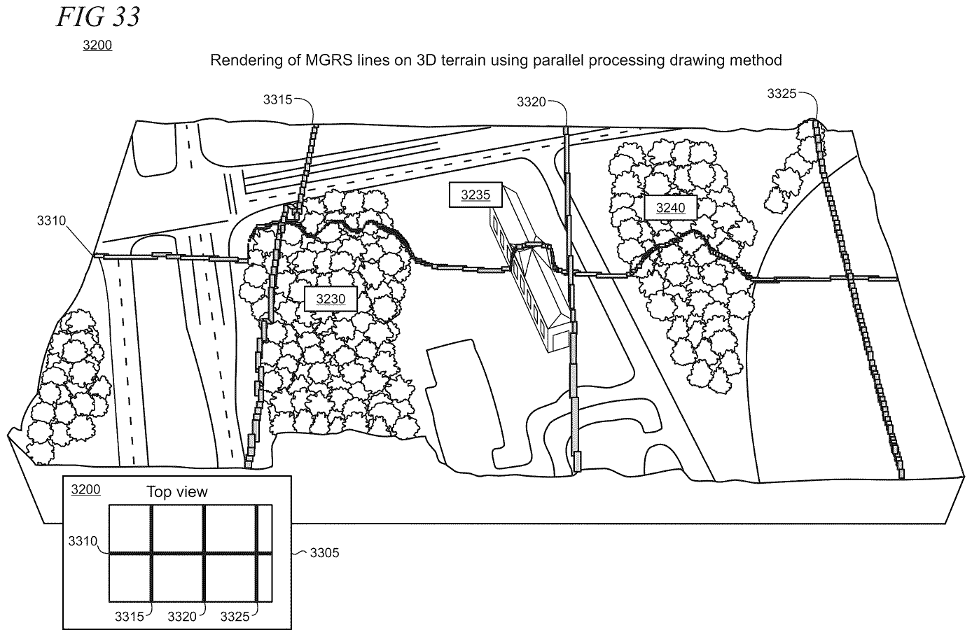

FIG. 33 shows the illustrative terrain 3200 which uses the same mesh (not shown) as in the previous example shown in FIG. 32. In this illustrative example, MGRS lines 3310, 3315, 3320, and 3325 are computed using the drawing tool 410 that utilizes the parallel processing drawing method described above and rendered as aggregated line rendering segments. Reference numeral 3305 indicates a reduced-size top view of the terrain and MGRS lines.

From a viewpoint shown in FIG. 33, it can be observed that the MGRS lines conform to the contours of all the features on the terrain with greater precision as compared with the lines drawn using conventional ray tracing shown in FIG. 32. For example, observing the MGRS line 3310 from left to right, the line conforms closely to the left of the trees 3230 which represent a large change in elevation. The MGRS line 3310 undulates over the top of trees 3230 to accurately conform to the variations in elevation in that area. The MGRS line 3310 conforms tightly at the junction with the ground to the right of the trees 3230. The MGRS line 3310 is drawn accurately at the sharp transitions between the building 3235 such that the gaps are minimized at both the left and right sides of the building 3235 compared to the line 3210 in FIG. 32. The MGRS line 3310 also more accurately conforms to the variations in elevation at the trees 3240 at the right side of the drawing.

Increased sampling density could potentially be used to better approximate the MGRS lines in the ray tracing example shown in FIG. 32. However, increased sampling requires more consumption of computing resources which can add latency to rendering on the display system and make the drawing experience less responsive to user inputs. While conventional ray tracing can provide satisfactory results in some applications, it is less well suited to being run on HMD devices where computing resources are limited.

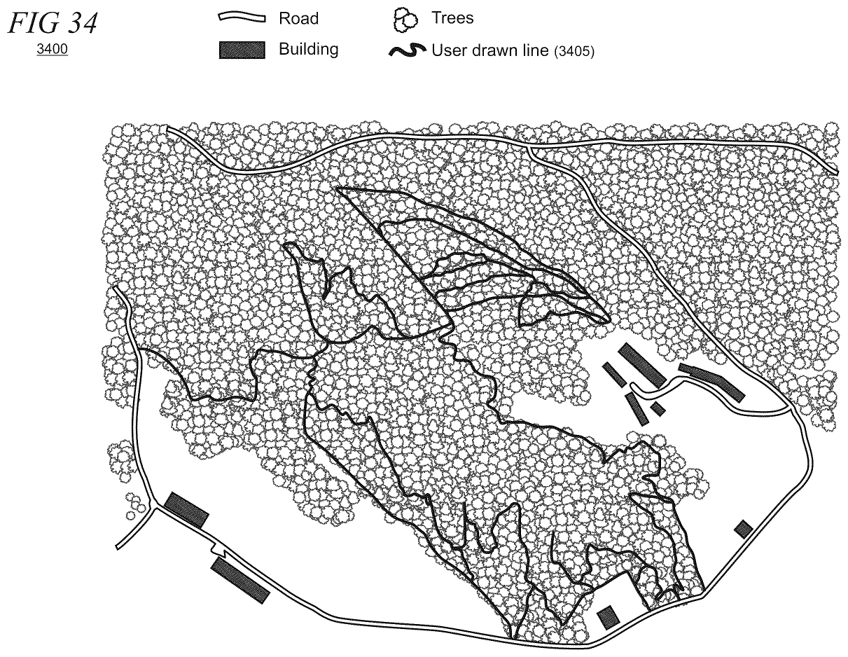

The inefficiencies of ray tracing are further compounded as mesh size and complexity increase which limits the extensibility of ray tracing approaches to large scale terrain marking applications. For example, FIG. 34 shows an illustrative section of terrain 3400 that encompasses several square kilometers from an elevated viewpoint looking downwards towards the center of the Earth (i.e., FIG. 34 depicts a top orthographic view of the terrain). Accordingly, the mesh associated with the terrain 3400 represents an increase in complexity by an order of magnitude or more as compared to the mesh associated with the terrain 3200 shown in FIG. 32.

The detailed turns and curves of the user-drawn line 3405 are not able to be effectively rendered using ray tracing. This is because the limitations imposed by resource-limited HMD devices provide for sampling density that is too low to accurately calculate and render the detailed lines. By comparison, the efficiency of the parallel processing employed by the drawing tool 410 enables the lines to be drawn quickly while accurately conforming to the mesh surfaces.

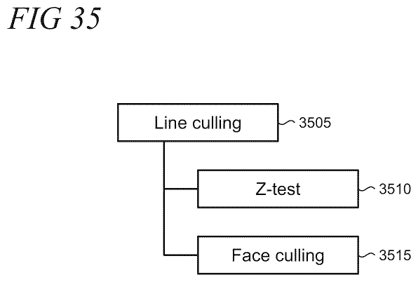

The parallel processing drawing method employed by the drawing tool 410 is extended in some implementations. For example, an extension includes line culling 3505, as shown in FIG. 35, to remove segments of a line drawn by the user 115 which are facing backwards from a given viewpoint. As the face of the backwards-facing line segment is not seen by the user, it does not need to be rendered. Line culling can increase performance of the drawing tool 410 in some cases by limiting calculations for lines that are not visible.

Line culling is implemented using two alternative embodiments. The first embodiment is a Z-test 3510 which occludes backwards facing triangles in a mesh since they are occluded by mesh in front of them. However, as entire objects are culled when any part of an object is occluded, Z-test culling can result in artifacts when parts of a line are occluded by the surrounding mesh. Artifacts can be minimized by defining a small offset that determines how high a line is sitting above the mesh (with a value of zero indicating that the line sits exactly on the mesh). This avoids a Z-fighting scenario which occurs when two surfaces are rendered at similar depths. The offset provides a depth value in the Z-buffer (i.e., depth buffer) that ensures that the line is distinct from the surrounding mesh.

The second embodiment of line culling is face culling 3515. For the large scale terrain example shown in FIG. 34 in which the viewpoint is above the terrain, face culling can be implemented by calculating the normal to each triangle in the line rendering segment and processing only the triangles in which the normal faces upwards. Downward facing triangles are not generated. No artifacts are associated with face culling.

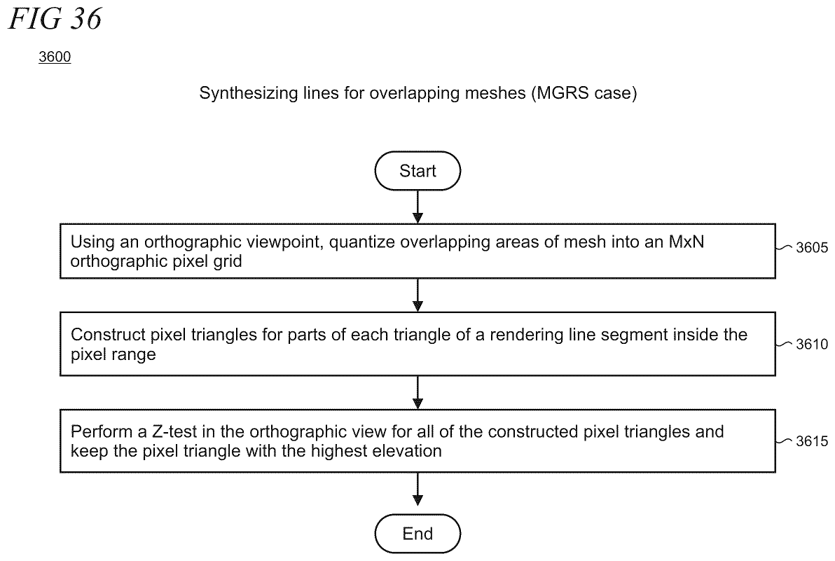

FIG. 36 is a flowchart 3600 for an extension of the parallel processing drawing method that deals with overlapping meshes in the MGRS example shown in FIG. 33. When a mesh for a modeled terrain is complex, for example by the meshes for trees extending over the meshes for the surrounding ground, the projection of the drawn MGRS lines downwards can result in multiple open or closed lines. Suitable lines need to be synthesized and drawn in such cases.

At block 3605 of the flowchart, by following the projection direction (i.e., downwards towards the center of the Earth), areas having overlapping meshes are quantized into an M×N orthographic pixel grid. Each pixel in the grid represents a small square of range. It can be appreciated that these pixels mimic the pixels in the orthographic top view.

Each of the triangles in a line rendering segment will occupy a number of pixels in the orthographic pixel grid. At block 3610, pixel triangles are constructed for each part of the triangle that is inside the pixel range.

At block 3615, a Z-test is performed, based on the orthographic viewpoint, for all of the constructed pixel triangles. The pixel triangles having the highest elevation in the Z-buffer are rendered. It is noted that blocks 3605 and 3610 of the flowchart can be performed in the compute shader 305 (FIG. 3) for each rendering line segment simultaneously using parallel processing, while block 3615 is performed in suitable stages of the graphics rendering pipeline 400 (FIG. 4).

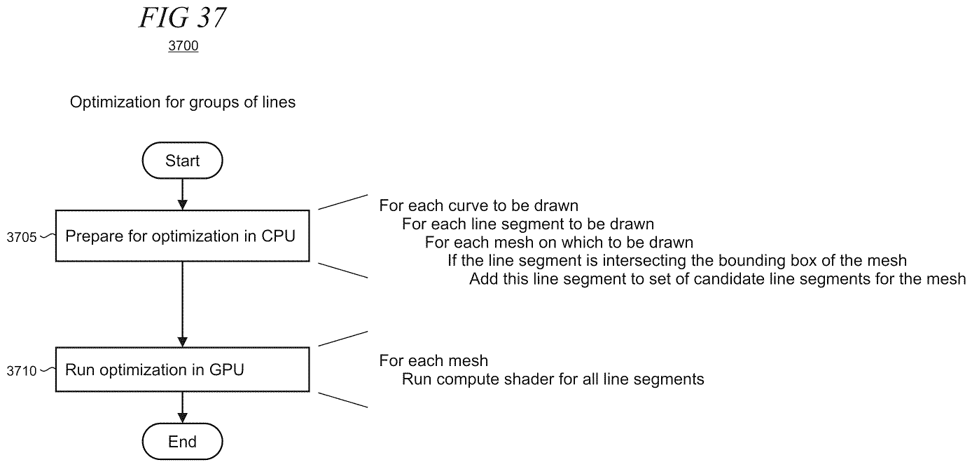

FIG. 37 is a flowchart 3700 for an extension of the parallel processing drawing method providing an optimization for drawing groups of lines on a mesh using a single pass of the compute shader 305 (FIG. 3). Performance of the drawing tool 410 using this optimization is increased by providing each line segment (which are aggregated to render the complete curve as discussed above) with its own bounding box information. The bounding box information is utilized to include or exclude the line segment from the compute shader pass for each mesh in a given scene.

At block 3705, preparation for the optimization is performed in the CPU 250 (FIG. 2). As shown in FIG. 37, the preparation includes steps to create a set of line segment candidates for the mesh:
For each curve to be drawn
   For each line segment to be drawn
      For each mesh on which to be drawn
         If the line segment is intersecting the bounding box of the mesh
         Add this line segment to set of candidate line segments for the mesh
            Other information that is related to the line segment such as color and primitive type is also tracked for the candidate set.

The optimization for groups of lines then continues at block 3710 which is performed in the GPU 255. As shown in FIG. 37, the compute shader 305 in the GPU simultaneously processes all of the line segments for the mesh.

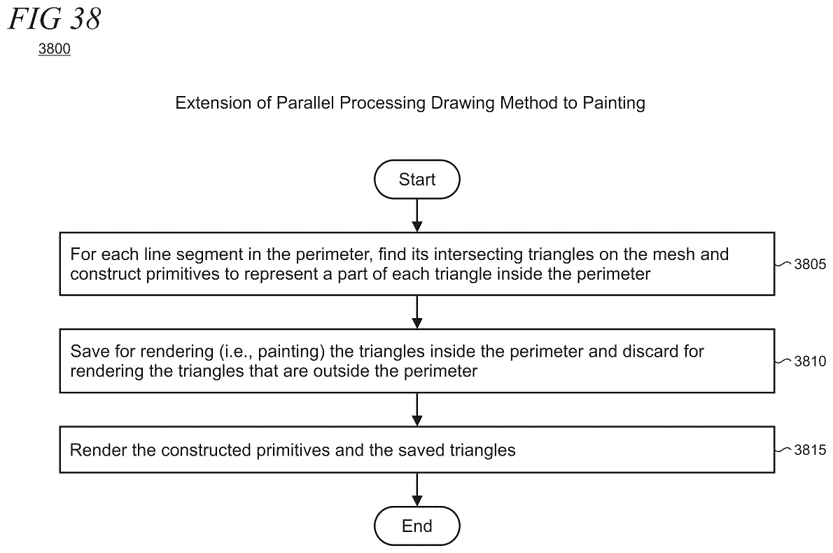

FIG. 38 is a flowchart 3800 for an extension of the parallel processing drawing method providing an optimization for painting on a mesh. Painting includes a drawing step and a fill step. The user draws an outline on portions of mesh surfaces and fills the outline with a color, texture, or other effect. For example, such effects may include light and illumination effects, 3D sculpting effects, animation effects, and the like. Various controls and options are typically surfaced to the user through the user interface 505 for the painting feature.

The extension starts with the user 115 drawing a perimeter curve to identify an area on an object to be painted. In typical implementations of painting, the user is provided with various options through the user interface to select the fill for the painted area. As noted above, any curve drawn by the user is handled by the drawing tool 410 as a series of individual lines (i.e., line segments).

At block 3805, the extension includes finding the intersecting triangles on the mesh for each line segment. This is the same process as with the single line example described in the text accompanying FIG. 24 above. Primitives are constructed to represent each part of the intersecting triangles that are inside the perimeter.

At block 3810, the triangles that are fully inside the perimeter are saved for rendering as part of the painted area. Triangles that are fully outside the perimeter are discarded for rendering because they are outside the painted area. At block 3815, the primitives constructed for the triangles intersecting with the drawn perimeter curve are rendered along with the saved triangles by applying a suitable effect-color, texture, lighting, etc.

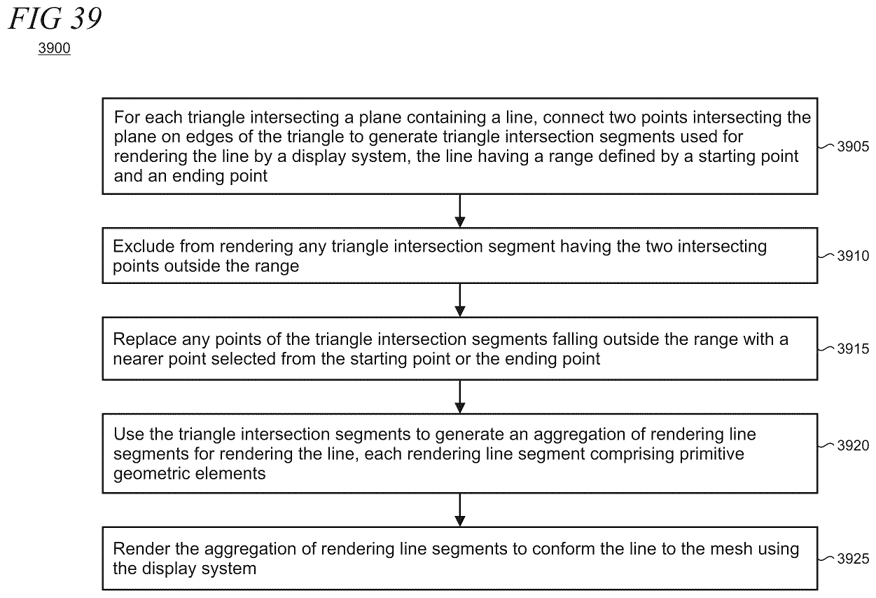

FIG. 39 is a flowchart 3900 of an illustrative method for implementing a drawing tool that enables a user of a computing device to virtually draw a line on an object modeled by a three-dimensional mesh of triangles. Block 3905 includes, for each triangle intersecting a plane containing the line, connecting two points intersecting the plane on edges of the triangle to generate triangle intersection segments used for rendering the line by a display system, in which the line has a range defined by a starting point and an ending point. Block 3910 includes excluding from rendering any triangle intersection segment having the two intersecting points outside the range.

Block 3915 includes replacing any points of the triangle intersection segments falling outside the range with a nearer point selected from the starting point or the ending point. Block 3920 includes using the triangle intersection segments to generate an aggregation of rendering line segments for rendering the line in which each rendering line segment comprises primitive geometric elements. Block 3925 includes rendering the aggregation of rendering line segments to conform the line to the mesh using the display system.

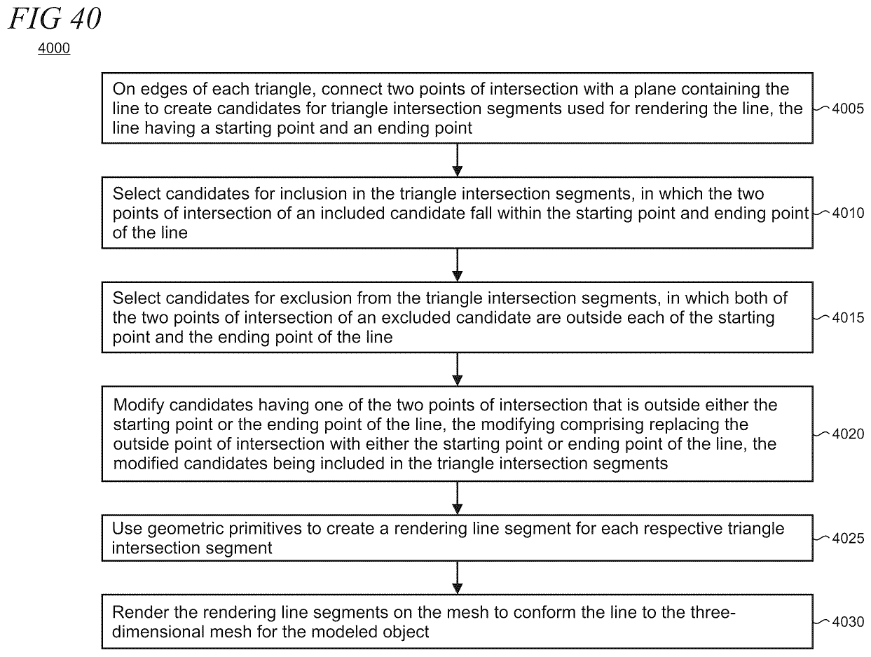

FIG. 40 is a flowchart 4000 of an illustrative method, running on a computing device by executing instructions stored on one or more machine-readable storage devices, for implementing a drawing tool that enables a user of a computing device to virtually draw a line on an object modeled by a three-dimensional mesh of triangles. Block 4005 includes, on edges of each triangle, connecting two points of intersection with a plane containing the line to create candidates for triangle intersection segments used for rendering the line, the line having a starting point and an ending point. Block 4010 includes selecting candidates for inclusion in the triangle intersection segments, in which the two points of intersection of an included candidate fall within the starting point and ending point of the line.

Block 4015 includes selecting candidates for exclusion from the triangle intersection segments, in which both of the two points of intersection of an excluded candidate are outside each of the starting point and the ending point of the line. Block 4020 includes modifying candidates having one of the two points of intersection that is outside either the starting point or the ending point of the line, the modifying comprising replacing the outside point of intersection with either the starting point or ending point of the line, the modified candidates being included in the triangle intersection segments.

Block 4025 includes using geometric primitives to create a rendering line segment for each respective triangle intersection segment. Block 4030 includes rendering the rendering line segments on the mesh to conform the line to the three-dimensional mesh for the modeled object.

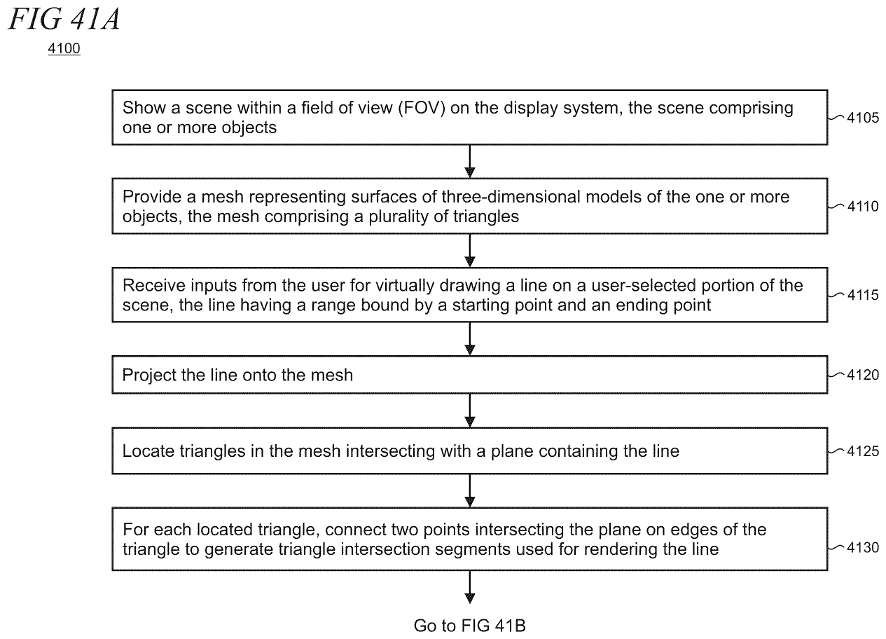

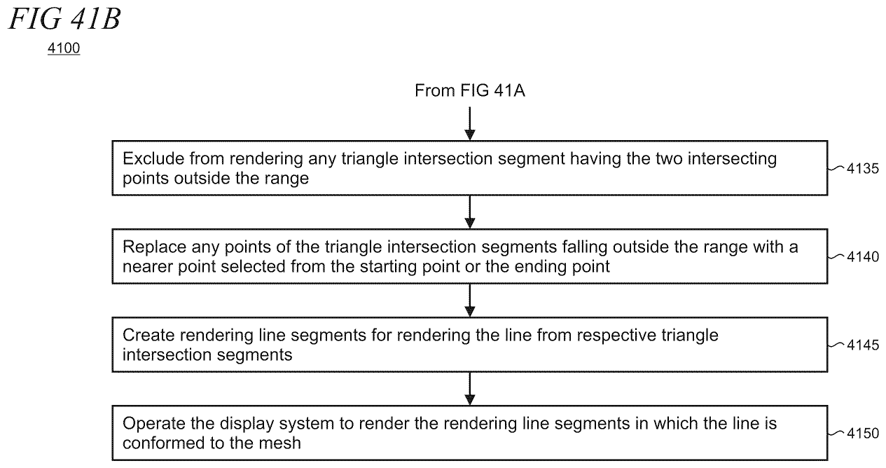

FIGS. 41A and 41B are a flowchart 4100 of an illustrative method that executes on an HMD device for providing a user-controlled drawing tool. The HMD device includes a processor, user interface, display system, and hardware-based storage device storing instructions that, when executed by the processor, cause the HMD to implement the method. Block 4105 of the method includes showing a scene within an FOV on the display system, in which the scene comprises one or more objects. Block 4110 includes providing a mesh representing surfaces of 3D models of the one or more objects, in which the mesh comprises a plurality of triangles.

Block 4115 includes receiving inputs from the user for virtually drawing a line on a user-selected portion of the scene, in which the line has a range bound by a starting point and an ending point. Block 4120 includes projecting the line onto the mesh. Block 4125 includes locating triangles in the mesh that intersect with a plane containing the line.

Block 4130 includes, for each located triangle, connecting two points intersecting the plane on edges of the triangle to generate triangle intersection segments used for rendering the line. Block 4135 includes excluding from rendering any triangle intersection segment having the two intersecting points outside the range. Block 4140 includes replacing any points of the triangle intersection segments falling outside the range with a nearer point selected from the starting point or the ending point.

Block 4145 includes creating rendering line segments for rendering the line from respective triangle intersection segments. Block 4150 includes operating the display system to render the rendering line segments in which the line is conformed to the mesh.

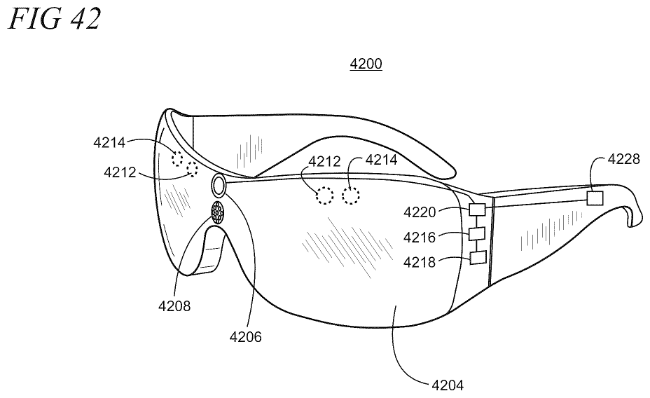

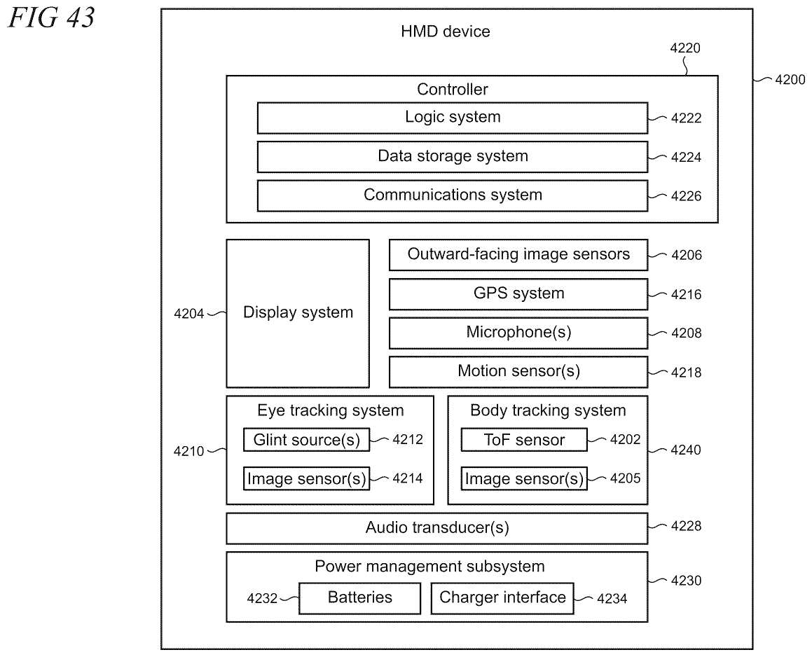

The drawing tool 410 may be implemented in HMD devices having a variety of form factors and features. FIG. 42 shows one particular illustrative example of a mixed-reality HMD device 4200, and FIG. 43 shows a functional block diagram of the HMD device. The HMD device comprises one or more lenses that form a part of a see-through display system 4204, so that virtual-world and real-world images are displayed to the HMD device user. For example, the display system may be arranged in a similar manner to the display system 105 described above.

The HMD device 4200 further comprises one or more outward-facing image sensors 4206 configured to acquire images of a background scene and/or physical environment being viewed by a user. Outward-facing image sensors 4206 can include one or more depth sensors and/or one or more two-dimensional image sensors. In alternative arrangements, a mixed-reality or virtual-reality display system displays mixed-reality or virtual-reality images through a viewfinder mode for an outward-facing image sensor or camera rather than incorporating a see-through display system. The HMD device 4200 also includes one or more microphones 4208 configured to detect sounds, such as voice commands from a user.

The HMD device 4200 further includes an eye tracking system 4210 configured for detecting a direction of gaze of each eye of a user or a direction or location of focus, as described above. The eye tracking system is configured to determine gaze directions of each of a user's eyes in any suitable manner. For example, in the illustrative example shown, the eye tracking system includes one or more glint sources 4212, such as infrared light sources, that are configured to cause a glint of light to reflect from each eyeball of a user, and one or more image sensors 4214, such as inward-facing sensors, that are configured to capture an image of each eyeball of the user. Changes in the glints from the user's eyeballs and/or a location of a user's pupil, as determined from image data gathered using the image sensors, are used to determine a direction of gaze.

In addition, a location at which gaze lines projected from the user's eyes intersect the external display is used to determine an object at which the user is gazing (e.g., a displayed virtual object and/or real background object). The eye tracking system 4210 has any suitable number and arrangement of light sources and image sensors.

The HMD device 4200 also includes additional sensors in some embodiments. For example, HMD device 4200 includes a global positioning system (GPS) system 4216 to allow a location of the HMD device 4200 to be determined. This may help to identify real-world objects, such as buildings, etc., that are located in the user's adjoining physical environment.

The HMD device 4200 further includes a body tracking system 4240 that may be implemented in a similar manner as the body tracking system 540 described above to track, for example, the hands of the user. The body tracking system typically uses sensors, either individual sensors or a combination of sensors such as ToF sensors 4202 and image sensors 4205 (e.g., visible light and/or IR cameras) to accurately track hand and/or body movements and gestures in real time. Multiple points of articulation are trackable, for example, for fingers, joints, and palms of the user.

The HMD device 4200 further includes one or more motion sensors 4218 (e.g., inertial, multi-axis gyroscopic, or acceleration sensors) to detect movement and position/orientation/pose of a user's head when the user is wearing the system as part of a mixed reality or virtual reality HMD device. Motion data is usable, potentially along with eye-tracking glint data and outward-facing image data, for gaze detection, as well as for image stabilization to help correct for blur in images from the outward-facing image sensors 4206. The use of motion data allows changes in gaze direction to be tracked even if image data from outward-facing image sensors 4206 cannot be resolved.

In addition, motion sensors 4218, microphones 4208, body tracking system 4240 and eye tracking system 4210, are employable as user input devices, such that a user interacts with the HMD device 4200 via gestures of the eye, neck and/or head, as well as via verbal commands in some cases. It may be understood that sensors illustrated in FIGS. 42 and 43 and described in the accompanying text are included for the purpose of example and are not intended to be limiting in any manner, as any other suitable sensors and/or combination of sensors are utilizable to meet the needs of a particular implementation. For example, biometric sensors (e.g., for detecting heart and respiration rates, blood pressure, brain activity, body temperature, etc.) or environmental sensors (e.g., for detecting temperature, humidity, elevation, UV (ultraviolet) light levels, etc.) are utilizable in some implementations.

The HMD device 4200 further includes a controller 4220 such as one or more processors having a logic system 4222 and a data storage system 4224 in communication with the sensors, eye tracking system 4210 and/or other components through a communications system 4226. The communications system 4226 facilitates the display system being operated in conjunction with remotely located resources, such as processing, storage, power, data, and services. That is, in some implementations, an HMD device is operable as part of a system that distributes resources and capabilities among different components and systems.

The data storage system 4224 includes instructions stored thereon that are executable by logic system 4222, for example, to receive and interpret inputs from the sensors, to identify location and movements of a user, to identify real objects using surface reconstruction and other techniques, and dim/fade the display based on distance to objects so as to enable the objects to be seen by the user, among other tasks. For purposes of this specification and the claims, the phrases “hardware-based storage device,” “computer-readable storage device,” “non-volatile storage device,” “data storage system,” and variations thereof, are intended to cover non-transitory embodiments, and do not include waves, signals, and/or other transitory and/or intangible communication media.

The HMD device 4200 is configured with one or more audio transducers 4228 (e.g., speakers, earphones, etc.) so that audio can be utilized as part of a mixed-reality or virtual-reality experience. A power management system 4230 includes one or more batteries 4232 and/or protection circuit modules (PCMs) and an associated charger interface 4234 and/or remote power interface for supplying power to components in the HMD device 4200.

It may be appreciated that the HMD device 4200 is described for the purpose of example, and thus is not meant to be limiting. It may be further understood that the display system includes, in some embodiments, additional and/or alternative sensors, cameras, microphones, input devices, output devices, etc. than those shown without departing from the scope of the present arrangement. Additionally, the physical configuration of an HMD device and its various sensors and subcomponents may take a variety of different forms without departing from the scope of the present arrangement.

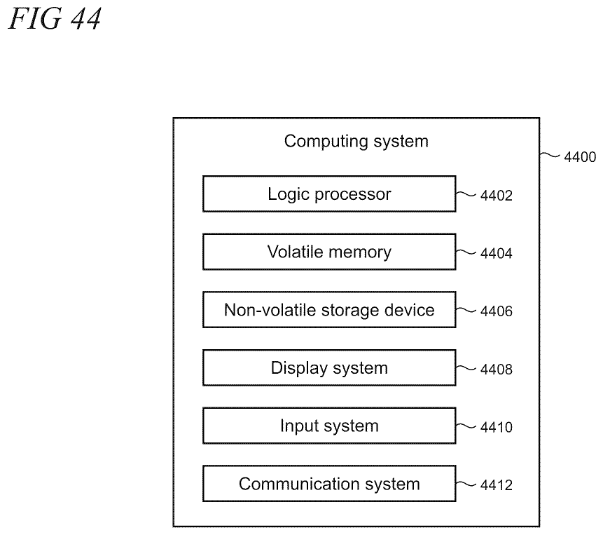

FIG. 44 schematically shows an illustrative example of a computing system 4400 that can enact one or more of the methods and processes described above. Computing system 4400 is shown in simplified form. Computing system 4400 may take the form of one or more personal computers, server computers, tablet computers, home-entertainment computers, network computing devices, gaming devices, mobile computing devices, mobile communication devices (e.g., smartphone), wearable computers, and/or other computing devices.

Computing system 4400 includes a logic processor 4402, volatile memory 4404, and a non-volatile storage device 4406. Computing system 4400 may optionally include a display system 4408, input system 4410, communication system 4412, and/or other components not shown in FIG. 44.

Logic processor 4402 includes one or more physical devices configured to execute instructions. For example, the logic processor may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more processors configured to execute software instructions. In addition, or alternatively, the logic processor may include one or more hardware or firmware logic processors configured to execute hardware or firmware instructions. Processors of the logic processor may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects may be run on different physical logic processors of various different machines.

Non-volatile storage device 4406 includes one or more physical devices configured to hold instructions executable by the logic processors to implement the methods and processes described herein. When such methods and processes are implemented, the state of non-volatile storage device 4406 may be transformed (e.g., to hold different data).

Non-volatile storage device 4406 may include physical devices that are removable and/or built-in. Non-volatile storage device 4406 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 4406 may include non-volatile, dynamic, static, read/write, read-only, sequential-access, location-addressable, file-addressable, and/or content-addressable devices. It will be appreciated that non-volatile storage device 4406 is configured to hold instructions even when power is cut to the non-volatile storage device 4406.

Volatile memory 4404 may include physical devices that include random access memory. Volatile memory 4404 is typically utilized by logic processor 4402 to temporarily store information during processing of software instructions. It will be appreciated that volatile memory 4404 typically does not continue to store instructions when power is cut to the volatile memory 4404.

Aspects of logic processor 4402, volatile memory 4404, and non-volatile storage device 4406 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The term “program” may be used to describe an aspect of computing system 4400 typically implemented in software by a processor to perform a particular function using portions of volatile memory, which function involves transformative processing that specially configures the processor to perform the function. Thus, a program may be instantiated via logic processor 4402 executing instructions held by non-volatile storage device 4406, using portions of volatile memory 4404. It will be understood that different programs may be instantiated from the same application, service, code block, object, library, routine, API (application programming interface), function, etc. Likewise, the same program may be instantiated by different applications, services, code blocks, objects, routines, APIs, functions, etc. The term “program” may encompass individual or groups of executable files, data files, libraries, drivers, scripts, database records, etc.

When included, display system 4408 may be used to present a visual representation of data held by non-volatile storage device 4406. This visual representation may take the form of a graphical user interface (GUI). As the herein described methods and processes change the data held by the non-volatile storage device, and thus transform the state of the non-volatile storage device, the state of display system 4408 may likewise be transformed to visually represent changes in the underlying data. Display system 4408 may include one or more display devices utilizing virtually any type of technology; however, one utilizing a MEMS projector to direct laser light may be compatible with the eye tracking system in a compact manner. Such display devices may be combined with logic processor 4402, volatile memory 4404, and/or non-volatile storage device 4406 in a shared enclosure, or such display devices may be peripheral display devices.

When included, input system 4410 may comprise or interface with one or more user-input devices such as a keyboard, mouse, touch screen, or game controller. In some embodiments, the input system may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication system 4412 may be configured to communicatively couple various computing devices described herein with each other, and with other devices. Communication system 4412 may include wired and/or wireless communication devices compatible with one or more different communication protocols. As non-limiting examples, the communication system may be configured for communication via a wireless telephone network, or a wired or wireless local- or wide-area network. In some embodiments, the communication system may allow computing system 4400 to send and/or receive messages to and/or from other devices via a network such as the Internet.

Various exemplary embodiments of the present drawing onto a surface of a three-dimensional mesh are now presented by way of illustration and not as an exhaustive list of all embodiments. An example includes a method, operable on a computing device, for implementing a drawing tool enabling a user of the computing device to virtually draw a line on an object modeled by a three-dimensional mesh of triangles, comprising: for each triangle intersecting a plane containing the line, connecting two points intersecting the plane on edges of the triangle to generate triangle intersection segments used for rendering the line by a display system, the line having a range defined by a starting point and an ending point; excluding from rendering any triangle intersection segment having the two intersecting points outside the range; replacing any points of the triangle intersection segments falling outside the range with a nearer point selected from the starting point or the ending point; using the triangle intersection segments to generate an aggregation of rendering line segments for rendering the line, each rendering line segment comprising primitive geometric elements; and rendering the aggregation of rendering line segments to conform the line to the mesh using the display system.

In another example, the primitive geometric elements for each rendering line segment comprise a pair of triangles arranged to form a quadrilateral having equal length opposite sides in which one set of the opposite sides represents a width of the rendered line. In another example, the method further comprises executing the method using a compute shader to compute the rendering line segments in a single pass. In another example, the rendering of the line is performed from the user's viewpoint within a field of view (FOV) of the display system, the viewpoint having an origin at eyes of the user or at a hand of the user. In another example, the method further includes culling rendering line segments that are facing backwards from the viewpoint, the culling comprising one of Z-Test or face culling. In another example, the method further includes configuring the drawing tool to enable the user to draw lines specifying a closed shape comprising a perimeter of an area of the mesh to be virtually painted. In another example, the method further includes finding triangle intersection segments that intersect the perimeter, constructing primitives to represent parts of each intersecting triangle inside the perimeter, finding non-intersecting triangles inside the perimeter, and rendering the non-intersecting triangles and constructed primitives to fill in the perimeter with a virtual painting effect comprising one or more of color, texture, lighting effect, sculpting effect, or animation. In another example, the method further includes providing a user interface to the drawing tool configured to enable the user to select attributes of the rendered line, the attributes including perimeter line width, perimeter line color, and fill effect. In another example, the method further includes receiving an input from the user selected from one or more of gaze, gesture, or position, location, or motion of a portion of the user's body including the user's hand or fingers.

A further example includes one or more machine-readable storage devices storing computer-executable instructions which, upon execution by a processor in a computing device, cause the computing device to implement a drawing tool for a user of the computing device to virtually draw a line on an object having surfaces modeled by a three-dimensional mesh of triangles, operations of the drawing tool comprising: on edges of each triangle, connecting two points of intersection with a plane containing the line to create candidates for triangle intersection segments used for rendering the line, the line having a starting point and an ending point; selecting candidates for inclusion in the triangle intersection segments, in which the two points of intersection of an included candidate fall within the starting point and ending point of the line; selecting candidates for exclusion from the triangle intersection segments, in which both of the two points of intersection of an excluded candidate are outside each of the starting point and the ending point of the line; modifying candidates having one of the two points of intersection that is outside either the starting point or the ending point of the line, the modifying comprising replacing the outside point of intersection with either the starting point or ending point of the line, the modified candidates being included in the triangle intersection segments; using geometric primitives to create a rendering line segment for each respective triangle intersection segment; and rendering the rendering line segments on the mesh to conform the line to the three-dimensional mesh for the modeled object.

In another example, the geometric primitives comprise a pair of triangles arranged in a rectangle in which a width of the rectangle matches a width of a rendering line segment. In another example, portions of the mesh are overlapping and a projection of the line onto the mesh results in multiple curves and wherein the drawing tool is further operated for synthesizing the multiple curves and rendering the synthesized curves. In another example, the synthesizing and rendering comprise quantizing the projection to an M×N orthographic pixel grid, constructing pixel triangles for portions of each of the pairs of triangles for the rendering line segments falling within the M×N orthographic pixel grid, performing a Z-test to cull constructed pixel triangles, and rendering the non-culled pixel triangles.

A further example includes a head-mounted display (HMD) device wearable by a user, comprising: a processor; a user interface, coupled to the processor, for receiving inputs from the user; a display system coupled to the processor; and a hardware-based storage device storing computer-executable instructions which, upon execution by the processor, cause the HMD device to implement a method for providing a user-controlled drawing tool comprising the steps of: showing a scene within a field of view (FOV) on the display system, the scene comprising one or more objects; providing a mesh representing surfaces of three-dimensional models of the one or more objects, the mesh comprising a plurality of triangles; receiving inputs from the user for virtually drawing a line on a user-selected portion of the scene, the line having a range bound by a starting point and an ending point; projecting the line onto the mesh; locating triangles in the mesh that intersect with a plane containing the line; for each located triangle, connecting two points intersecting the plane on edges of the triangle to generate triangle intersection segments used for rendering the line; excluding from rendering any triangle intersection segment having the two intersecting points outside the range; replacing any points of the triangle intersection segments falling outside the range with a nearer point selected from the starting point or the ending point; creating rendering line segments for rendering the line from respective triangle intersection segments; and operating the display system to render the rendering line segments in which the line is conformed to the mesh.

In another example, the scene is one of a virtual-world scene, a real-world scene, or a mixed virtual- and real-world scene and the one or more objects are virtual objects or real-world objects. In another example, the HMD device further comprises a body tracking system for tracking position, orientation, or motion of parts of the user's body as inputs to the user interface. In another example, the HMD device further comprises a depth sensor configured for capturing data used by the processor to create a mesh of a real-world object in the scene. In another example, the scene comprises one or more of terrain, trees, and manmade objects. In another example, the HMD device further includes a compute shader incorporated in the processor, the compute shader configured to perform the projecting, locating, connecting, excluding, replacing, and creating steps as parallel processes for each rendering line segment. In another example, the HMD device further includes a graphics rendering pipeline incorporated in the processor, the graphics rendering pipeline and compute shader operating separately and independently, wherein the graphics rendering pipeline renders the rendering line segments in aggregation.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method, operable on a computing device, for implementing a drawing tool enabling a user of the computing device to virtually draw a line on an object modeled by a three-dimensional mesh of triangles, comprising:
for each triangle intersecting a plane containing the line, connecting two points intersecting the plane on edges of the triangle to generate triangle intersection segments used for rendering the line by a display system, the line having a range defined by a starting point and an ending point;
excluding from rendering any triangle intersection segment having the two intersecting points outside the range;
replacing any points of the triangle intersection segments falling outside the range with a nearer point selected from the starting point or the ending point;
using the triangle intersection segments to generate an aggregation of rendering line segments for rendering the line, each rendering line segment comprising primitive geometric elements; and
rendering the aggregation of rendering line segments to conform the line to the mesh using the display system.

2. The method of claim 1 in which the primitive geometric elements for each rendering line segment comprise a pair of triangles arranged to form a quadrilateral having equal length opposite sides in which one set of the opposite sides represents a width of the rendered line.

3. The method of claim 1 further comprising executing the method using a compute shader to compute the rendering line segments in a single pass.

4. The method of claim 1 in which the rendering of the line is performed from the user's viewpoint within a field of view (FOV) of the display system, the viewpoint having an origin at eyes of the user or at a hand of the user.

5. The method of claim 4 further including culling rendering line segments that are facing backwards from the viewpoint, the culling comprising one of Z-Test or face culling.

6. The method of claim 1 further including configuring the drawing tool to enable the user to draw lines specifying a closed shape comprising a perimeter of an area of the mesh to be virtually painted.

7. The method of claim 6 further including finding triangle intersection segments that intersect the perimeter, constructing primitives to represent parts of each intersecting triangle inside the perimeter, finding non-intersecting triangles inside the perimeter, and rendering the non-intersecting triangles and constructed primitives to fill in the perimeter with a virtual painting effect comprising one or more of color, texture, lighting effect, sculpting effect, or animation.

8. The method of claim 7 further including providing a user interface to the drawing tool configured to enable the user to select attributes of the rendered line, the attributes including perimeter line width, perimeter line color, and fill effect.

9. The method of claim 1 further including receiving an input from the user selected from one or more of gaze, gesture, or position, location, or motion of a portion of the user's body including the user's hand or fingers.

10. One or more machine-readable storage devices storing computer-executable instructions which, upon execution by a processor in a computing device, cause the computing device to implement a drawing tool for a user of the computing device to virtually draw a line on an object having surfaces modeled by a three-dimensional mesh of triangles, operations of the drawing tool comprising:
on edges of each triangle, connecting two points of intersection with a plane containing the line to create candidates for triangle intersection segments used for rendering the line, the line having a starting point and an ending point;
selecting candidates for inclusion in the triangle intersection segments, in which the two points of intersection of an included candidate fall within the starting point and ending point of the line;
selecting candidates for exclusion from the triangle intersection segments, in which both of the two points of intersection of an excluded candidate are outside each of the starting point and the ending point of the line;
modifying candidates having one of the two points of intersection that is outside either the starting point or the ending point of the line, the modifying comprising replacing the outside point of intersection with either the starting point or ending point of the line, the modified candidates being included in the triangle intersection segments;
using geometric primitives to create a rendering line segment for each respective triangle intersection segment; and
rendering the rendering line segments on the mesh to conform the line to the three-dimensional mesh for the modeled object.

11. The one or more machine-readable storage devices of claim 10 in which the geometric primitives comprise a pair of triangles arranged in a rectangle in which a width of the rectangle matches a width of a rendering line segment.

12. The one or more machine-readable storage devices of claim 11 wherein portions of the mesh are overlapping and a projection of the line onto the mesh results in multiple curves and wherein the drawing tool is further operated for synthesizing the multiple curves and rendering the synthesized curves.

13. The one or more machine-readable storage devices of claim 12 in which the synthesizing and rendering comprise quantizing the projection to an M×N orthographic pixel grid, constructing pixel triangles for portions of each of the pairs of triangles for the rendering line segments falling within the M×N orthographic pixel grid, performing a Z-test to cull constructed pixel triangles, and rendering the non-culled pixel triangles.

14. A head-mounted display (HMD) device wearable by a user, comprising:
a processor;
a user interface, coupled to the processor, for receiving inputs from the user;
a display system coupled to the processor; and
a hardware-based storage device storing computer-executable instructions which, upon execution by the processor, cause the HMD device to implement a method for providing a user-controlled drawing tool comprising the steps of:
showing a scene within a field of view (FOV) on the display system, the scene comprising one or more objects;
providing a mesh representing surfaces of three-dimensional models of the one or more objects, the mesh comprising a plurality of triangles;
receiving inputs from the user for virtually drawing a line on a user-selected portion of the scene, the line having a range bound by a starting point and an ending point;
projecting the line onto the mesh;
locating triangles in the mesh that intersect with a plane containing the line;
for each located triangle, connecting two points intersecting the plane on edges of the triangle to generate triangle intersection segments used for rendering the line;
excluding from rendering any triangle intersection segment having the two intersecting points outside the range;
replacing any points of the triangle intersection segments falling outside the range with a nearer point selected from the starting point or the ending point;
creating rendering line segments for rendering the line from respective triangle intersection segments; and
operating the display system to render the rendering line segments in which the line is conformed to the mesh.

15. The HMD device of claim 14 in which the scene is one of a virtual-world scene, a real-world scene, or a mixed virtual- and real-world scene and the one or more objects are virtual objects or real-world objects.

16. The HMD device of claim 14 further comprising a body tracking system for tracking position, orientation, or motion of parts of the user's body as inputs to the user interface.

17. The HMD device of claim 14 further comprising a depth sensor configured for capturing data used by the processor to create a mesh of a real-world object in the scene.

18. The HMD device of claim 14 in which the scene comprises one or more of terrain, trees, and manmade objects.

19. The HMD device of claim 14 further including a compute shader incorporated in the processor, the compute shader configured to perform the projecting, locating, connecting, excluding, replacing, and creating steps as parallel processes for each rendering line segment.

20. The HMD device of claim 19 further including a graphics rendering pipeline incorporated in the processor, the graphics rendering pipeline and compute shader operating separately and independently, wherein the graphics rendering pipeline renders the rendering line segments in aggregation.
